(19) United States
(12) Patent Application Publication
(10) Pub. No.: US 2002/0059058 A1
(43) Pub. Date: May 16, 2002

(54) MARGIN ANALYSIS SYSTEM

(76) Inventors: AARON P. DOOLIN, NEW LONDON, MN (US); IVAN R. WELLS, LIBERTY, MO (US); JOEL L. DEKKERS, SPICER, MN (US)

Correspondence Address: MERCHANT & GOULD PC, P.O. BOX 2903, MINNEAPOLIS, MN, 55402-0903, US

(21) Appl. No.: 08/885,087

(22) Filed: Jun. 30, 1997

Related U.S. Application Data
(63) Continuation of application No. 08/299,698, filed on Sep. 1, 1994, now abandoned.

(51) Int. Cl. G06F 17/60; G06F 17/21

(52) U.S. Cl. 704/10

(57) ABSTRACT

A computer-implemented margin determination and revenue forecasting system for automatically determining margins of products sold across a selling period. The system's margin determination assists a seller of products in business planning by providing for an accurate estimation of total profits derived from products sold. Such a determination assists in ongoing managing of profits derived from sales of products during the selling period. The system also provides for determining the level of sales activity desired based on the level of revenue desired to be generated. The system comprising a terminal for receiving and displaying margin control data, data storage electrically interconnected to the terminal for storing the product data and the margin control data and a programmed processor, electrically interconnected to the terminal and the data storage, for processing the data received at the terminal, the programmed processor including a program for processing the product data and the margin control data in order to automatically determine and display the margin income data across the selling period. The system also determines and displays sales forecast data for products anticipated being sold across the selling period.

### TECHNICAL FIELD OF THE INVENTION

The present invention pertains generally to a computer implemented system for determining margins and profits related to products sold during a specified period, and for forecasting income to be generated over the specified period.

### BACKGROUND OF THE INVENTION

It is well known that a salesman of products typically takes into consideration a number of factors when setting prices for products where a defined margin is desired to be cleared and specific profit goals are desired to be reached. Some of the factors that may be considered are: cost of money borrowed to purchase the products, manufacturer rebate incentives, the date the products were sold on, and the desired margin. Taking such these factors into consideration when pricing products makes the process extremely cumbersome. The manufacturer rebate is a complex problem because the income derived from the rebates, which is taken into consideration to determine total profits, is provided on a sliding scale based on the number of products sold. In the past, such problems have prevented sellers from accurately pricing products in a manner that insures profits, unless the above factors were taking into consideration in separate hand calculations for each product. Such a task is virtually impossible where there is a significant number of products anticipated sold at varying levels by a seller. Adding further complications to pricing determination are factors such as the constantly changing interest rate.

A system is needed that prices different products purchased from manufacturers quickly and efficiently and automatically takes into consideration the above varying factors.

### SUMMARY

To meet the needs outlined above, and provide other advantageous benefits and functions, the present invention provides a computer-implemented margin income determination system for automatically determining margins of products sold across a selling period. The present invention further provides a system that accurately calculates desired margins and thus provides a seller with the opportunity to expand its pricing by providing incentive discounts for its customers without the fear of losing its profit margin. Such a system allows a user to plan its business by making accurate revenue determinations based on sales estimates. It also supports income management and business decisions. The system also forecasts profits across a selling period for aiding its user in managing profits derived from products sold during the selling period.

The system comprises: a terminal for receiving and displaying data including product data identifying particular products, margin control data, margin income data, and beginning and ending dates defining a selling period; data storage electrically interconnected to the terminal means for storing the product data and the margin control data; and a programmed processor electrically interconnected to the terminal and the data storage, for processing the data received at the terminal, the programmed processor including a program for processing the product data and the margin control data in order to automatically determine and display the margin income data across the selling period.

### BRIEF DESCRIPTION OF THE DRAWINGS

In the drawings, wherein like reference letters and numerals designate corresponding elements throughout the several views:

FIG. 1 is a simplified block diagram of a margin determination and income forecasting system;

FIG. 2 is a simplified block diagram of a data flow structure of the margin determination and income forecasting system of FIG. 1;

FIG. 3 is a simplified block diagram of a data flow structure of a margin determination module within the margin determination and income forecasting system of FIG. 1;

FIG. 4 is a simplified block diagram of a data flow structure of an edit products option within the margin determination module of FIG. 3;

FIG. 5 is a simplified block diagram of a data flow structure of a system options within the margin determination module of FIG. 3;

FIG. 6 is a simplified block diagram of a data flow structure of a setup option within the margin determination module of FIG. 3;

FIG. 7 is a simplified block diagram of a data flow structure of a utilities options within the margin determination module of FIG. 3;

FIG. 8 is a simplified block diagram of a data flow structure of a rebuild option within the margin determination module of FIG. 3;

FIG. 9 is a simplified block diagram of a data flow structure of an income forecasting module within the margin determination and income forecasting system of FIG. 1;

FIGS. 10a and 10b are simplified block diagrams of data flow structures of a supplier summaries option within the income determination module of FIG. 9;

FIG. 11 is a simplified block diagram of a data flow structure of a per acre summaries option within the income determination module of FIG. 9;

FIG. 12a is an illustration of a main menu for software of the margin determination and income forecasting system of FIG. 1;

FIG. 12b is an illustration of a main menu screen display of the margin determination module of FIG. 3;

FIG. 12c is an illustration of a choose products option screen display of a choose products option within the margin determination module of FIG. 3;

FIG. 12d is an illustration of a set margins option screen display of a set margins option within the margin determination module of FIG. 3;

FIG. 12e is an illustration of an edit products product maintenance screen display within the margin determination module of FIG. 3;

FIG. 12f is an illustration of an edit products option screen display within the margin determination module of FIG. 3;

FIG. 12g is an illustration of an add products option screen within the edit products product maintenance option of FIG. 12e;

FIG. 12h is an illustration of a change products screen display within the edit products product maintenance option of FIG. 12e;

FIG. 12i is an illustration of a view/print option screen display within the margin determination system of FIG. 3;

FIG. 13a is an illustration of the income forecasting module of FIG. 9 screen display;

FIG. 13b is an illustration of an edit products option screen display within the income forecasting module of FIG. 13a;

FIG. 13c is an illustration of a supplier summary screen display within the income forecasting module of FIG. 13a;

FIG. 13d is an illustration of an individual supplier's summary screen display within a supplier summary option within the income forecasting module of FIG. 13a;

FIG. 13e is an illustration of a per acre summaries option screen display within the income forecasting module of FIG. 13a;

FIG. 13f is an illustration of a price per acre screen display within a per acre summaries option within the income forecasting module of FIG. 13a;

FIG. 13g is an illustration of an income per acre summary screen display within a per acre summaries option of the income forecasting module of FIG. 13a;

FIG. 14a is an illustration of a sample price report;

FIG. 14b is an illustration of a sample cost and margin report;

FIG. 15a is a flow chart of a choose products option within the margin determination module of FIG. 3;

FIG. 15b is a flow chart of a set margins option within the margin determination module of FIG. 3;

FIGS. 15c-15e are flow charts of an edit products option within the margin determination module of FIG. 3;

FIG. 15f is a flow chart of a view/print option within the margin determination module of FIG. 3;

FIG. 15g is a flow chart of system access to the income forecasting module of FIG. 9;

FIG. 15h is a flow chart of an edit records option within the income forecasting module of FIG. 9;

FIG. 15i is a flow chart of a supplier summaries option within the income forecasting module of FIG. 9;

FIGS. 15j through 15k are flow charts of a per acre summaries option within the income forecasting module of FIG. 9;

FIG. 15l is a flow chart of a print option within the income forecasting module of FIG. 9;

FIG. 16a is an illustration of a sample price per acre report;

FIG. 16b is an illustration of a sample grower cost per acre price report; and

FIG. 16c is an illustration of a sample income per acre report.

### GENERAL DESCRIPTION

The preferred computer implemented margin determination and income forecasting system is comprised of two software modules, the MARGIN MAKER™ margin determination module (hereinafter referred to as the MARGIN MAKER™ module), and the DECISION MAKER™ income forecasting module (hereinafter referred to as the DECISION MAKER™ module). It is to be understood that, when the reference is made to the “MARGIN MAKER™ module” in the present application, such language is intended as an abbreviated form of ”MARGIN MAKER™ margin determination module” and that when reference is made to the “DECISION MAKER™ module” in the present application, such language is intended as an abbreviated form of “DECISION MAKER™ income forecasting module.”

The MARGIN MAKER™ module provides for the determination of margins on products sold at different times in a selling period. The DECISION MAKER™ module forecasts total profits and margins on products anticipated being sold during the selling period. The DECISION MAKER™ module also aids the seller in managing profits for the selling period and assists the system user in determining which products to sell during the selling period for purposes of maximizing profits.

The selling period is a period of time defined by the user during which products will be sold. The selling period can be any length of time defined by the user. In the preferred embodiment, the selling periods are usually six months or less, and typically based around the product cost on December 31 or May 31.

The preferred system has a main product records database that specifies a plurality of products which the seller may use to identify products anticipated being sold during the selling period. The main product records data base may be comprised of a plurality of product records. In the preferred embodiment, each product record includes 8 fields of margin control data: number, name, category, package size, December 31 product cost, May 31 product cost, Manufacturers high rebate, and Manufacturers low rebate.

The product number is typically a unique identification for each product. In the preferred embodiment, which has been designed for use in agricultural product sales, the product category defines four groups, chemical, 2,4-D, micronutrient or fertilizer. Each product is typically assigned to one of these groups.

The package size specifies the units in which each product is typically sold (e.g. gallons, pounds or ounces). The December 31 and May 31 cost dates specify the manufacturer's product list price on those dates. The Manufacturers high and low rebate fields represent the sliding scale range guidelines of the manufacturer rebate control data that defines a maximum and minimum rebate allowable to sellers on the sale of products. The actual rebate given to a seller is normally determined by the sellers sales volume (e.g. on a particular product there may be a minimum rebate of 1% and a maximum rebate of 10% the rebate the seller actually receives is determined by the volume of products sold, sales of 10,000 units may allow for a rebate of 6% or sales of 20,000 units may allow for a rebate of 8%).

The MARGIN MAKER™ module provides for the determination of margins on products sold at different times in a selling period. In the preferred system, the first step in margin determination is to identify products the user anticipates selling from the main product records database. The products identified are retrieved and stored along with any other products the seller anticipates selling that are not found in the main product records database. These products comprise the margin product records database.

Following the creation of the margin product records database, the system prompts the user at labeled and defined fields for entry of margin control data. In the preferred embodiment, the margin control data entered includes: beginning and ending dates for the selling period, dealer cost date, cost of money percentage rate, and discount rates. Margin income data is normally generated from computer processing of data within each margin product records and the data input by the user. In the preferred embodiment, the margin income data generated includes a product base price, monthly product prices and the associated margin and discount rates provided on products sold during the months of the selling period.

The system also provides for the generation of a product price report, illustrating the margin income data for the products identified across the selling period. The product price report typically illustrates the margin income data as an array of product prices for each product in response to computer processing of each product's cost defined in the product record. The array of product prices illustrates the price of a product at a different times during the selling period.

In the preferred embodiment, the MARGIN MAKER™ module also provides for the generation of a cost and margin report illustrating for each product, the package size, product beginning date cost, units, and margins for the beginning and ending dates of the selling period.

The DECISION MAKER™ module typically forecasts profits over the selling period by computer processing of the margin data base records, margin income and manufacturer rebate control data, and an anticipated number of sales for each product over the selling period. The DECISION MAKER™ module provides an outline illustrating the forecasted profits for the anticipated number of products to be sold over the selling period. The system may also provide a field for the entry of additional income that the seller may desire to take into account for purposes of balancing the selling period's sales budget.

In the preferred embodiment, the outline produced by the DECISION MAKER™ module includes for each product within the margin records database, a product name, package size, sales price, anticipated number of products sold, margin income per unit, manufacturer rebate income per unit, units in which the products are sold, margin percentage and manufacturer rebate percentage. The outline also includes a summary for all products sold. The summary includes a margin percentage total, sales total, income total, margin income total and manufacturer rebate total. The outline may be used as an income planning tool. It provides a user with the ability to plan revenues and margin percentages around realistic forecasted sales activities and manufacturer rebates provided.

In the preferred embodiment, the DECISION MAKER™ module also provides for the forecasting of income generated for each product sold on a per acre basis. The system automatically performs this processing following entry of a rate per acre by which each product is applied. The system automatically generates cost per acre and income per acre summary reports for each product sold. These summary reports assist the user in determining which products to sell during the selling period. Although the preferred embodiment of the present invention is described in the context of agricultural product sales, it is to be understood that the present invention is not limited to agriculture and may have relevance to the sale of other products.

### DETAILED DESCRIPTION OF SPECIFIC EMBODIMENT

In the following detailed description of the preferred embodiment, reference is made to the accompanying drawings which form a part hereof and in which is shown by way of illustration an exemplary embodiment and a description having sufficient detail to enable those skilled in the art to practice the invention. Although the preferred embodiment is explained in the context of agricultural products sales, it is to be understood that other embodiments may be utilized and that structural or logical changes may be made without departing from the scope of the present invention. The following detailed description is, therefore, not to be taken in a limiting sense, and the scope of the present invention is defined by the appended claims.

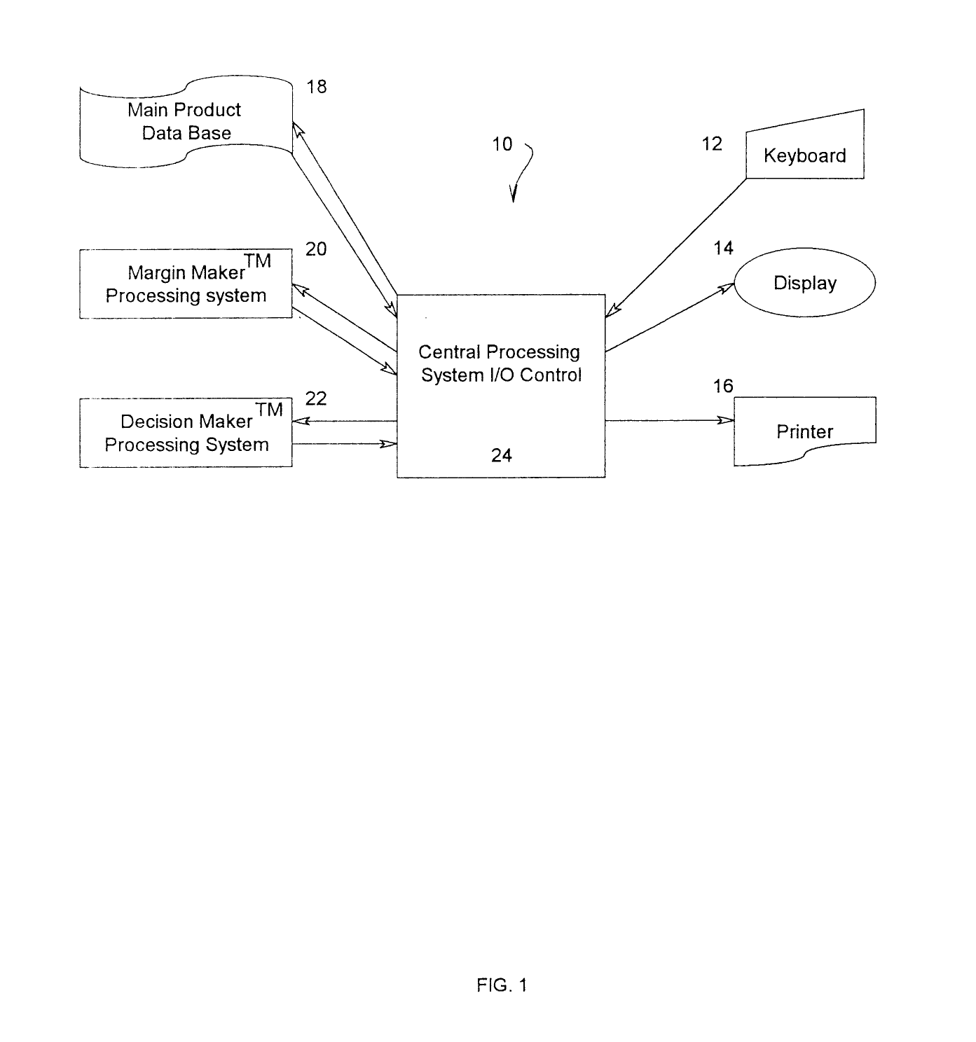

Referring to FIG. 1 a simplified overview of the preferred embodiment of the present invention will be described. FIG. 1 shows a simplified block diagram of the margin determination and income forecasting system 10. The system 10 includes a keyboard 12 for data entry, selection and manipulation, a CRT display 14, a printer 16, a Main Product database 18 having a plurality of product records, a MARGIN MAKER™ module processing system 20, a DECISION MAKER™ module processing system 22, and a Central Processing unit 24. In the exemplary embodiment of the system 10 described herein, the central processor unit 24 is IBM compatible, operating the MS-DOS operating system in the Microsoft® Windows™ environment. However, it shall be understood that the software for the present invention could be written to run on other computer systems, including, for example, an IBM Apple Macintosh computer system.

### Data Flow

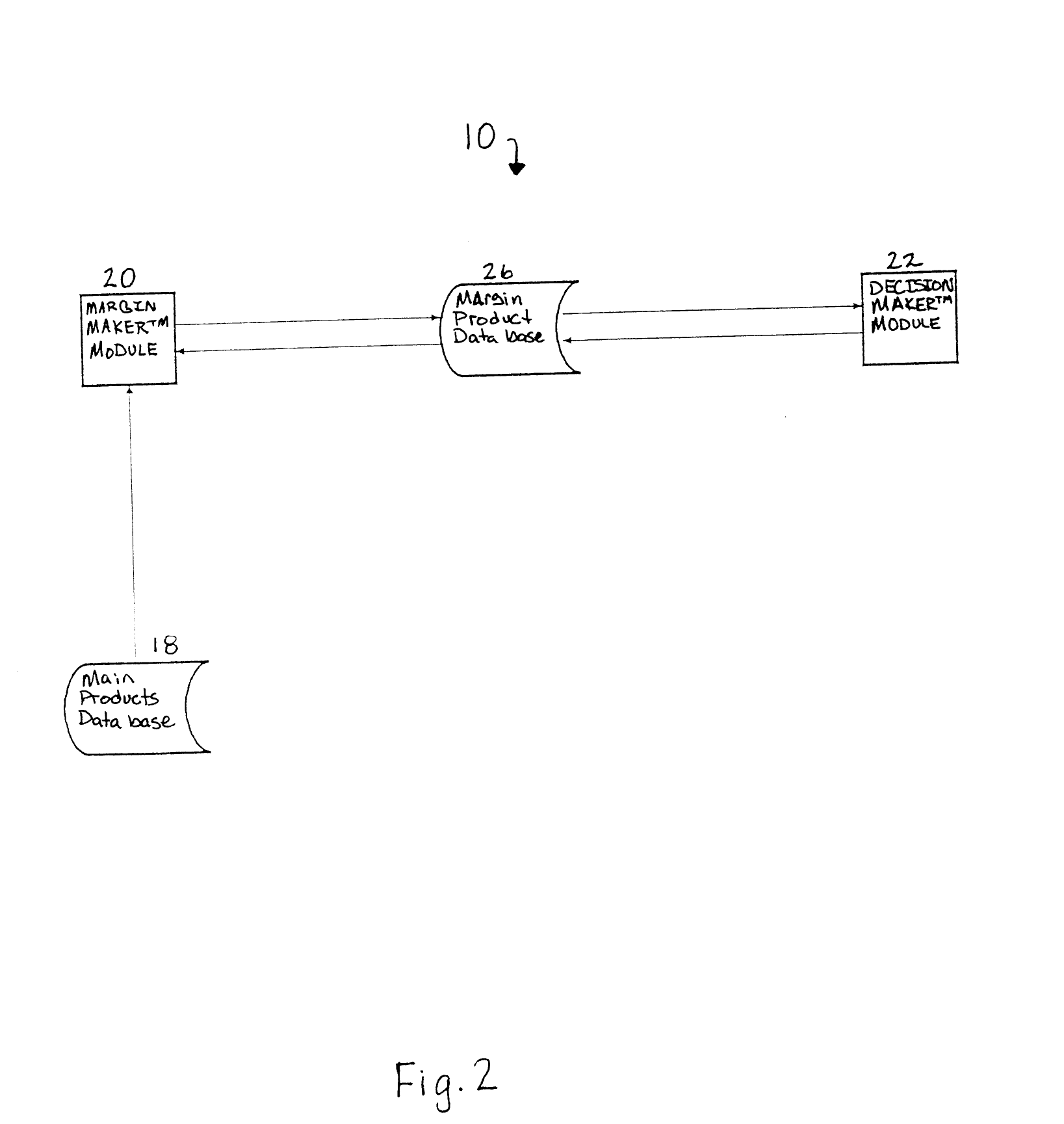

The preferred margin determination and income forecasting system 10 consists of three main components: a main product records database 18, a MARGIN MAKER™ module 20, and a DECISION MAKER™ module 22. Referring now to FIG. 2, there is shown an overview of data flow between the major components of the preferred margin determination and income forecasting system 10. Data records are retrieved from the main product records data base 18 when the MARGIN MAKER™ module 20 is activated. The MARGIN MAKER™ module 20 provides for the selection of data records from the main product records data base 18. The records selected are stored as the margin product records data base 26. These data records within the margin product records data base 26 may be accessed by the MARGIN MAKER™ module 20 and DECISION MAKER™ module 22 to perform various functions.

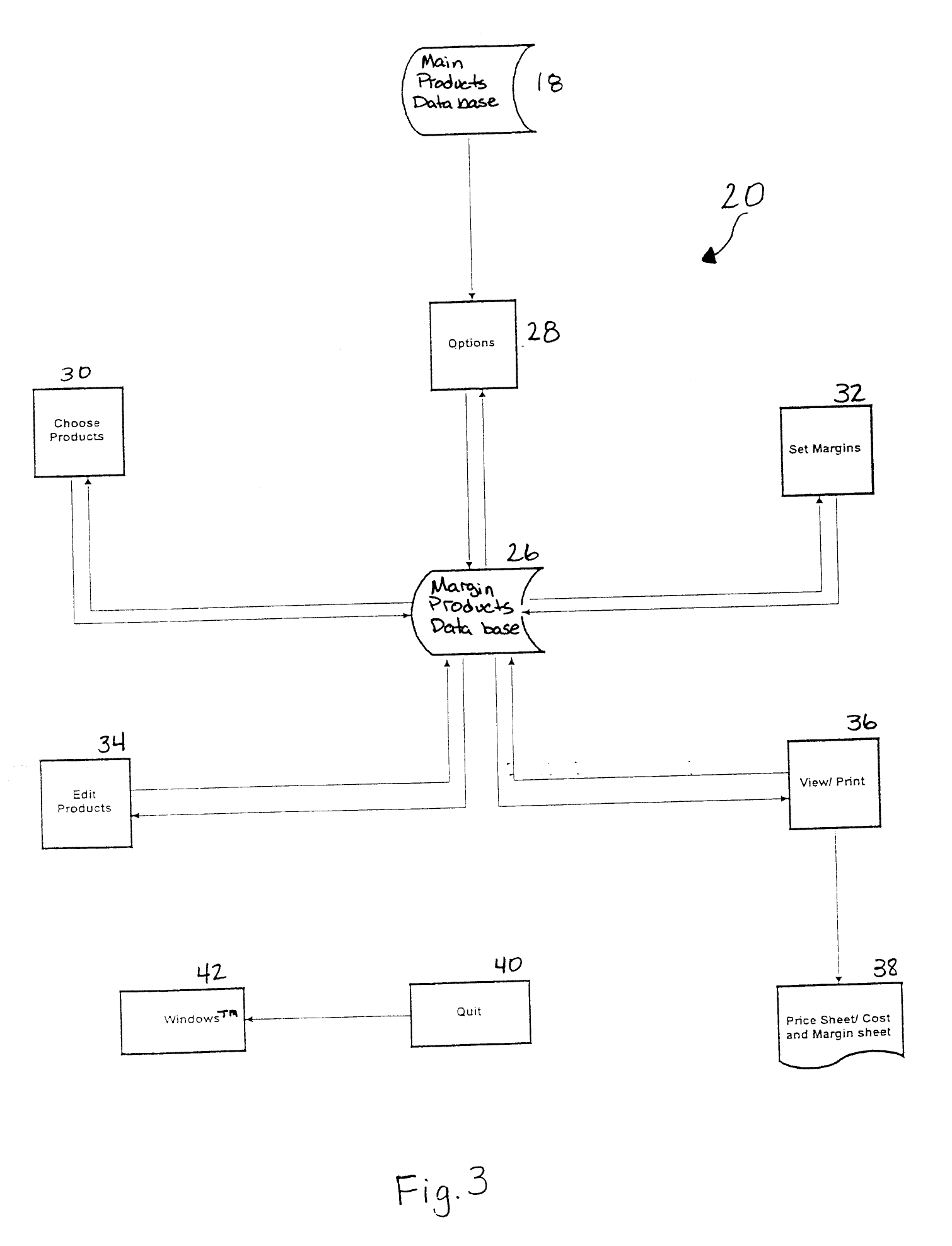

Referring now to FIG. 3 there is shown an illustration of data flow during the MARGIN MAKER™ module 20 processing. The preferred MARGIN MAKER™ module 20 is comprised of four modules, choose products 30 set margins 32, edit products 34 and view/print 36. There is also an options module 28 within the preferred MARGIN MAKER™ module that typically has five functions, setup, utilities, rebuild, import, and export (shown in FIGS. 5-8.). Each of these functions provide for the further customization of the records within the margin product records data base 26.

The choose products module 30 within the MARGIN MAKER™ module 20 allows the user to access the main product records data base 18 for the identification of products which are anticipated being sold during the selling period. The product records for this list of identified products is stored in a margin product records data base 26.

The set margins module 32 within the MARGIN MAKER™ module 20 allows for the parameters of the user's price sheet to be set and for the setting of a global margin for all of the products in the main products records database 18.

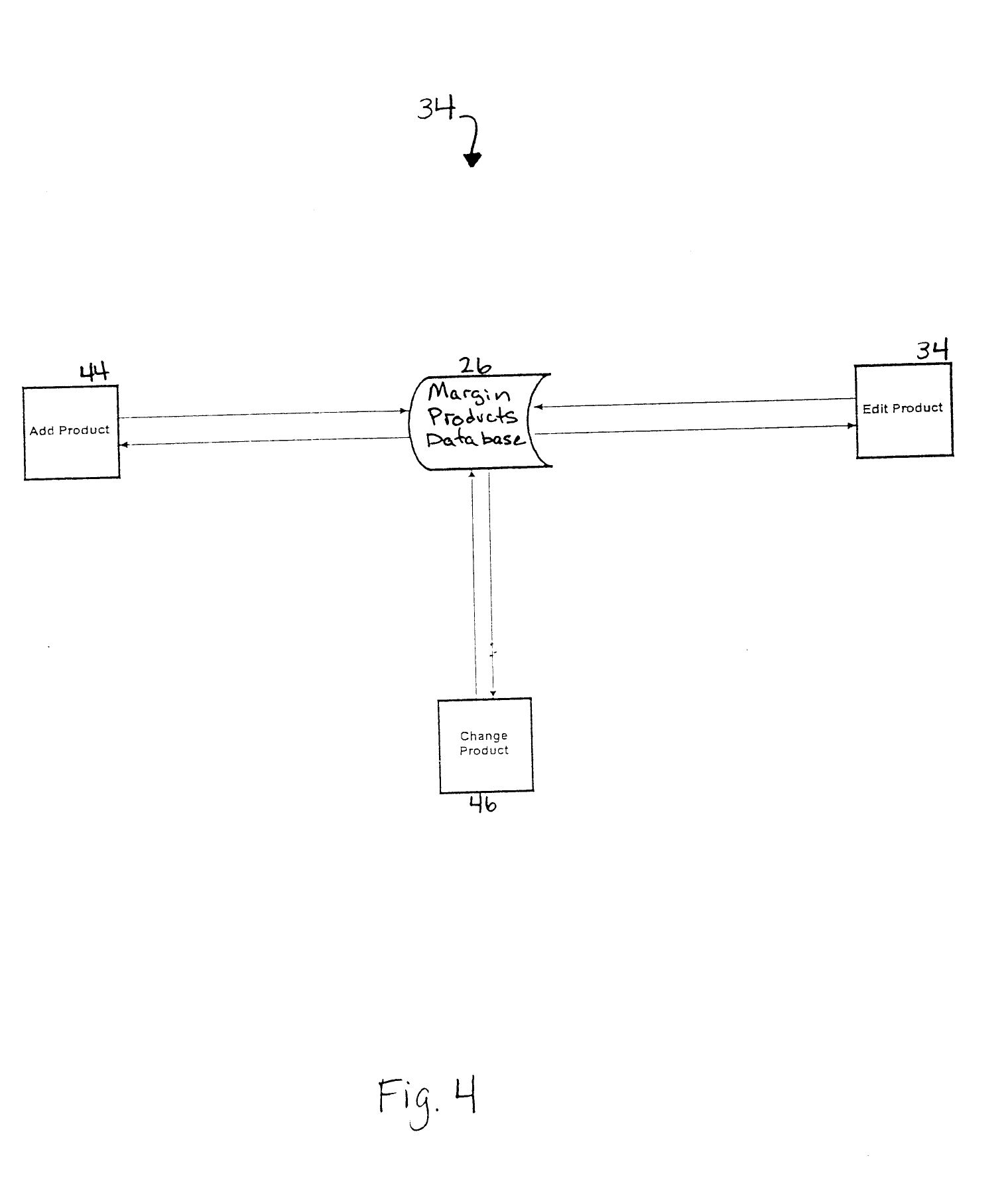

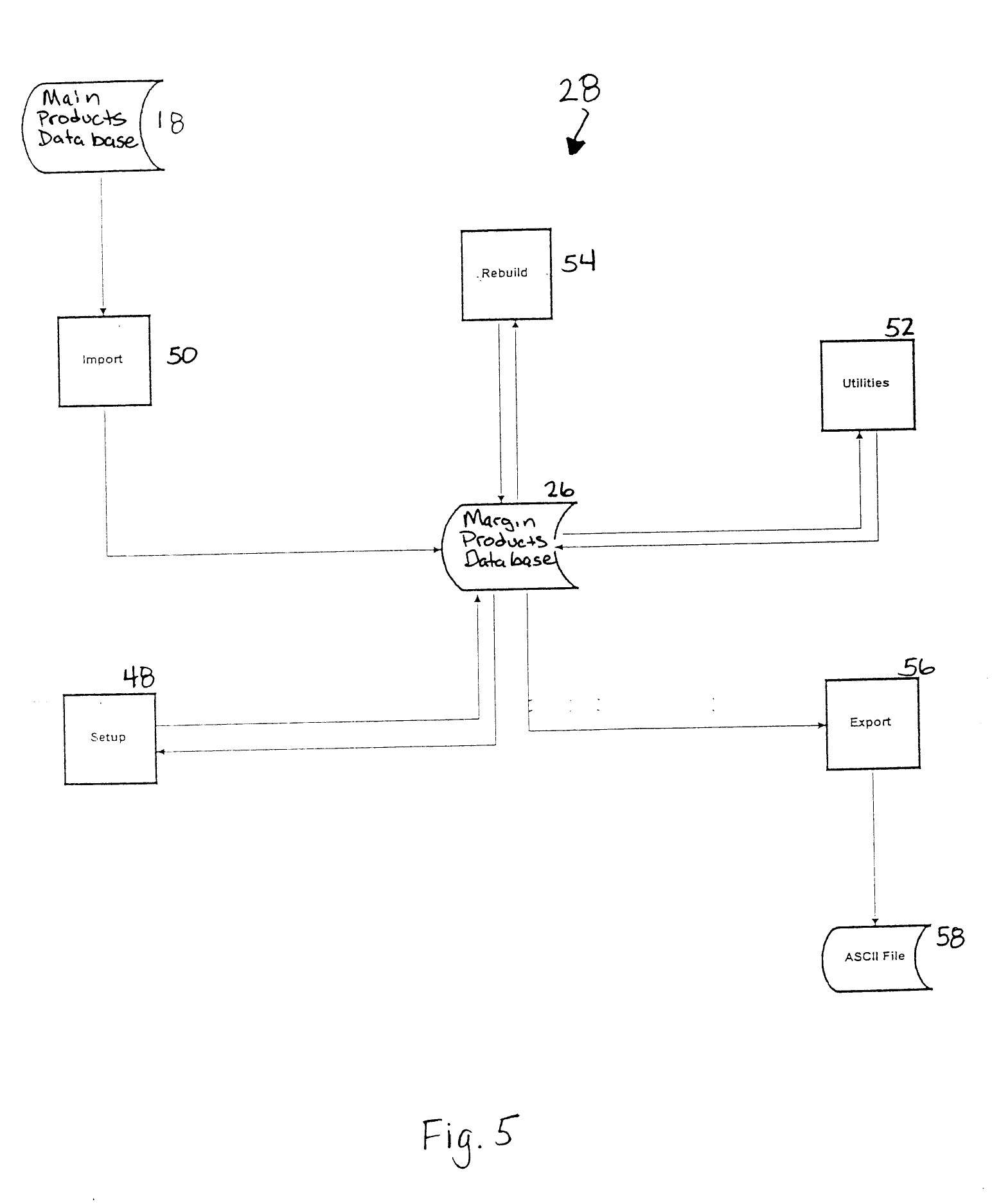

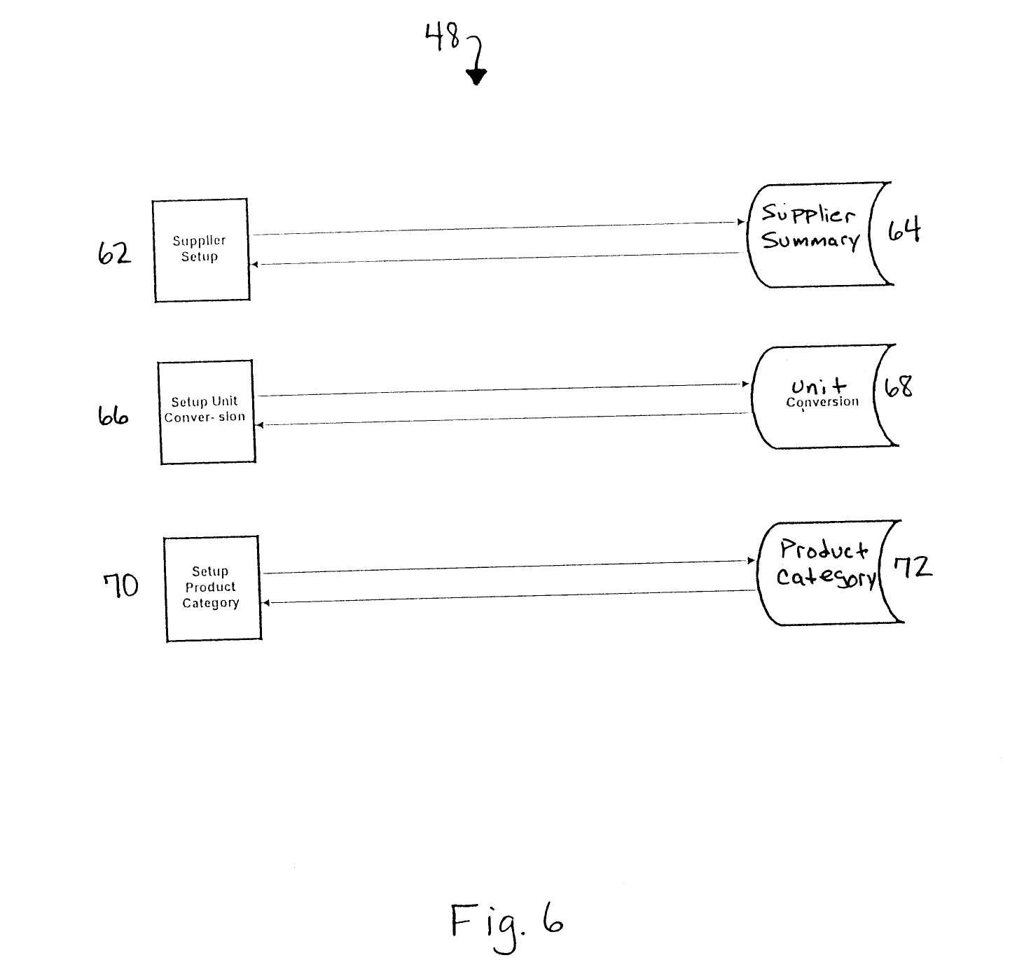

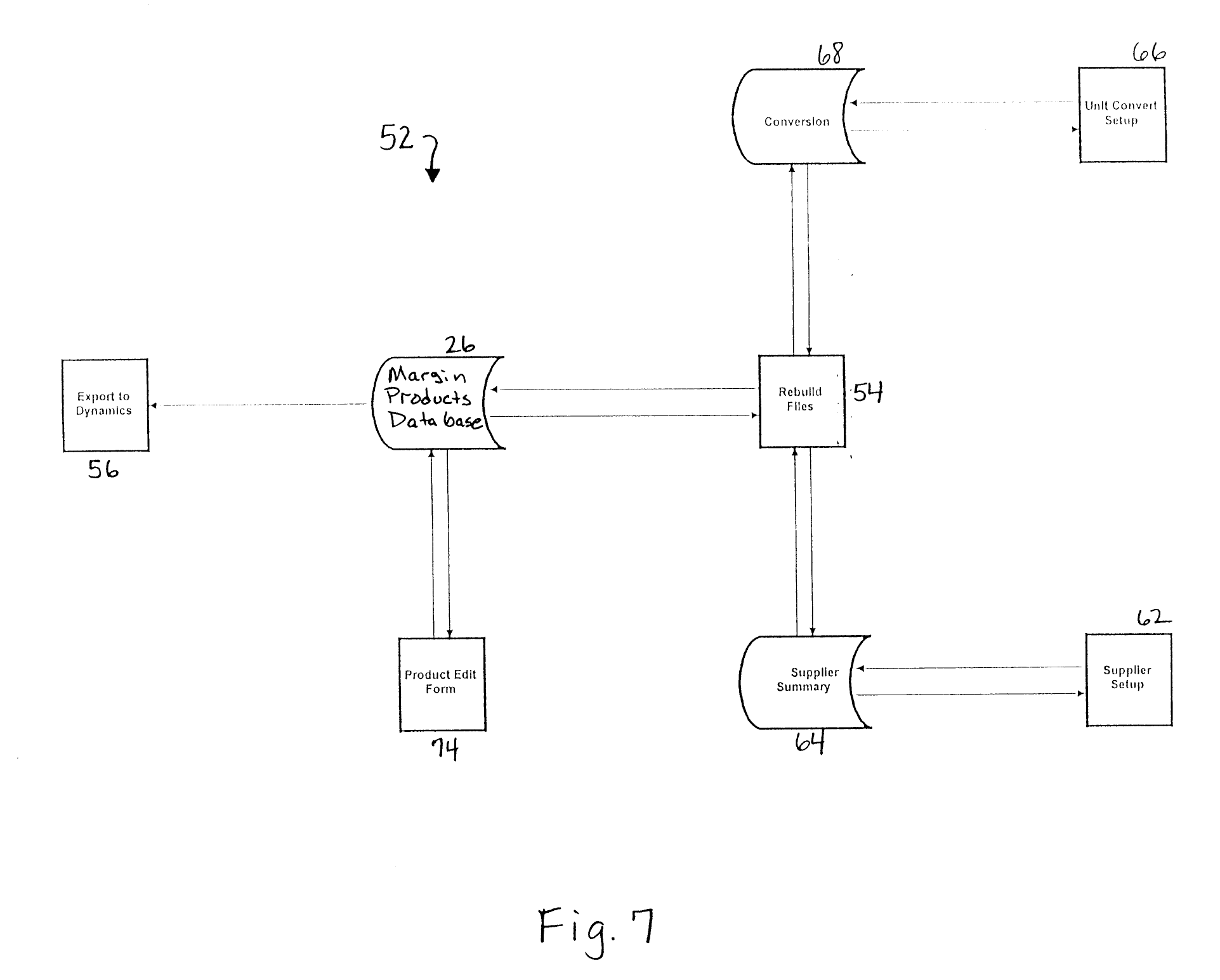

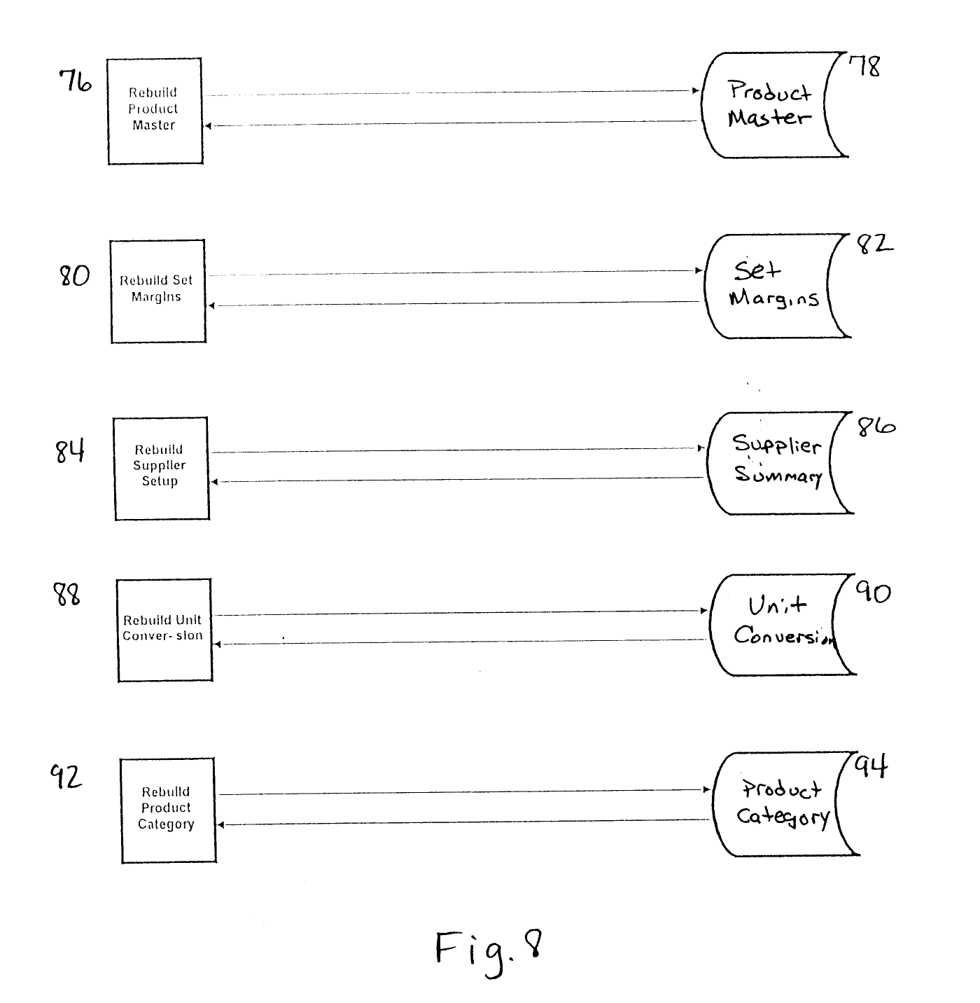

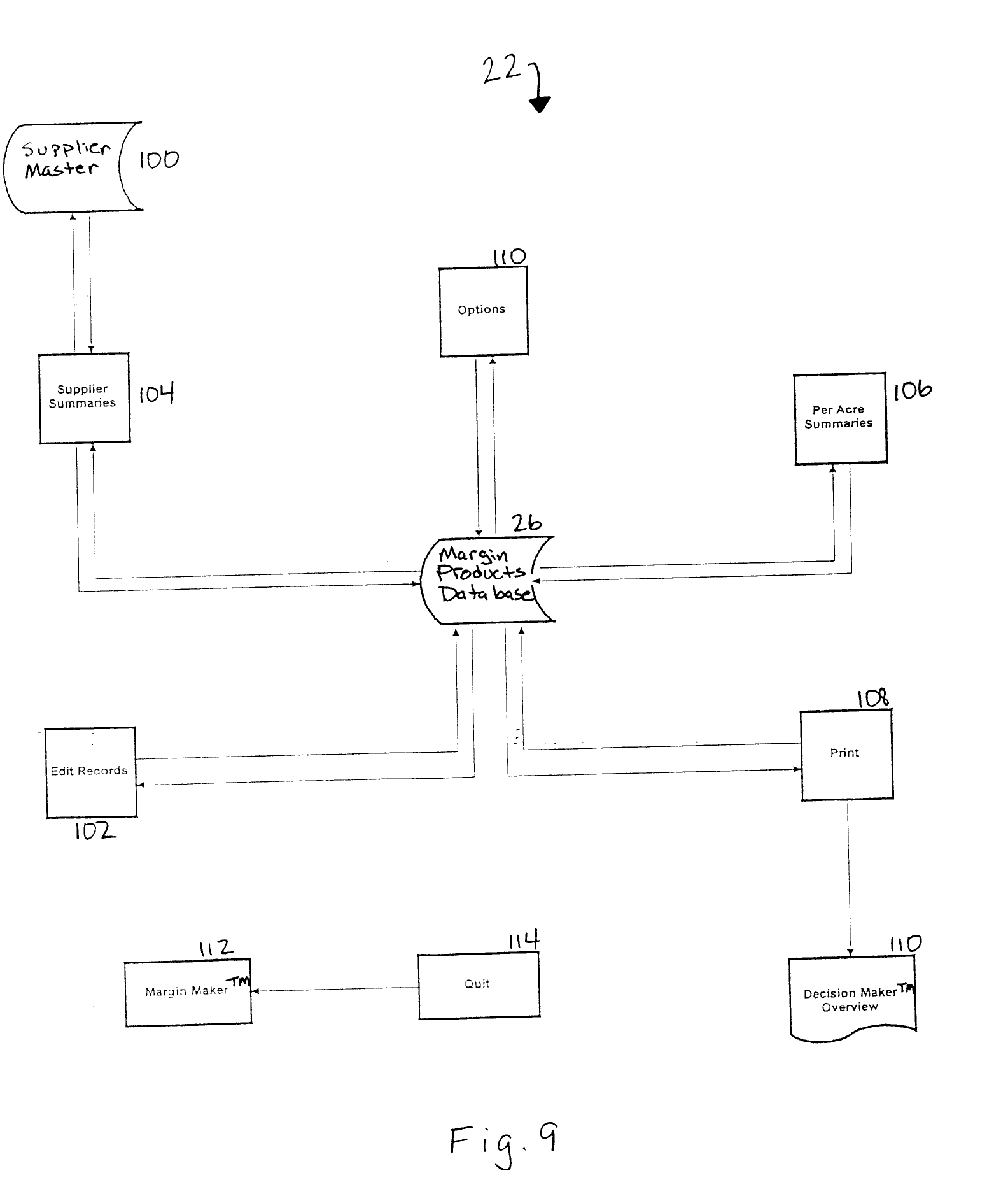

The edit products module 34 within the MARGIN MAKER™ module 20 allows for the modification of individual products records within the main product records data base 18. Edit products 34 also allows the user to add products not found in the main product records data base 18 through its Add Products function 44, shown in FIG. 4. The products added may be modified through Edit Product's Change Product function 46. These additional products added and those identified in Choose Products make up the margin product records data base 26 of the preferred embodiment.

The view/print module 36 within the MARGIN MAKER™ module 20, as shown in FIG. 3, allows the user to view the price sheet before printing, print the price sheet, print a cost and margin sheet 38 and transfer the print sheet to a word processing file. Upon completion of the MARGIN MAKER™ module processing and viewing and/or printing of the price sheet/cost and margin sheets, the MARGIN MAKER™ module may be exited 40 to a windows 42 environment.

The MARGIN MAKER™ module also provides for the further customization of the identified records within the margin product data base 26. The customization is normally performed by accessing the option 28 functions within the MARGIN MAKER™ module shown in FIGS. 5-8. There are typically five options available, setup 48, import 50, utilities 52, rebuild 54, and export 56.

The set up option 48, also shown in FIG. 6 typically has three functions, supplier set-up 62, conversion table set-up 66 and product category set-up 70. The supplier summary set-up 62 option allows for the modification of DECISION MAKER module's supplier summary 64 is set-up. The conversion table set-up 66 option allows for modification of units in which products are sold in 68. The product category set-up option 70 allows the priority of the product categories to be changed 72. Such a product category modification changes the order in which margin product records are listed, since they are typically stored in alphabetical order in each category.

FIG. 7 is an illustration of data flow through accessing system utilities. FIG. 8 is an illustration of data flow through a system rebuild. The system rebuild option allows for the rebuilding of the product master 76, 78, set margins 80, 82, supplier summary set-up 84, 86, unit conversion 88, 90 and product category 92, 94.

Referring now to FIG. 9, there is shown an illustration of data flow during DECISION MAKER module 22 processing. DECISION MAKER module 22 is normally comprised of four modules, edit records 102, supplier summary 104, per acre summary 106 and print 108. There is also an option module 110 within DECISION MAKER module 22 that typically has two functions, set-up and utilities (not shown).

The edit records module 102, allows the user change the product margin on each product. It also allows for the entry of a sales forecast of the anticipated number of products sold, and manufacturer rebate.

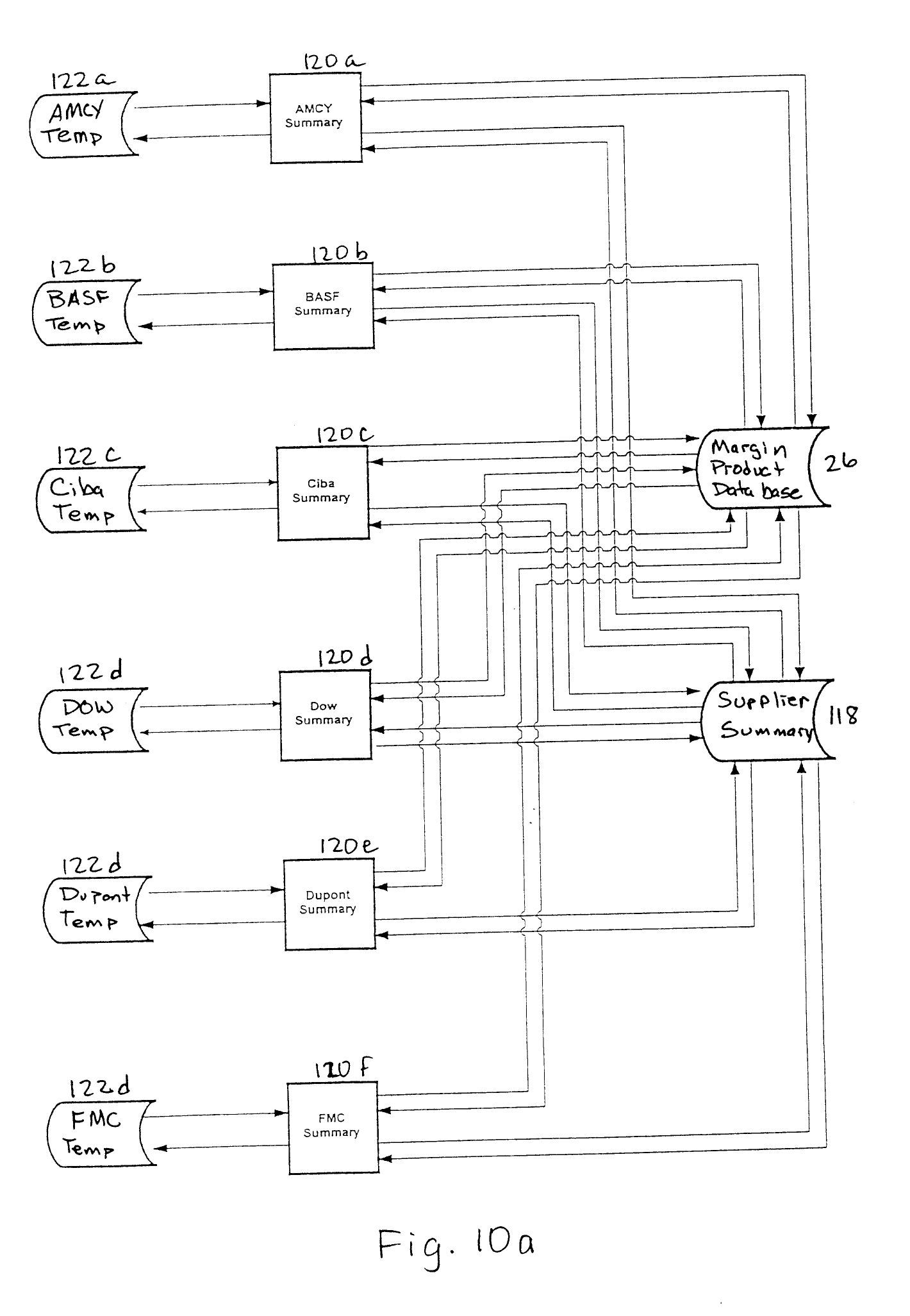

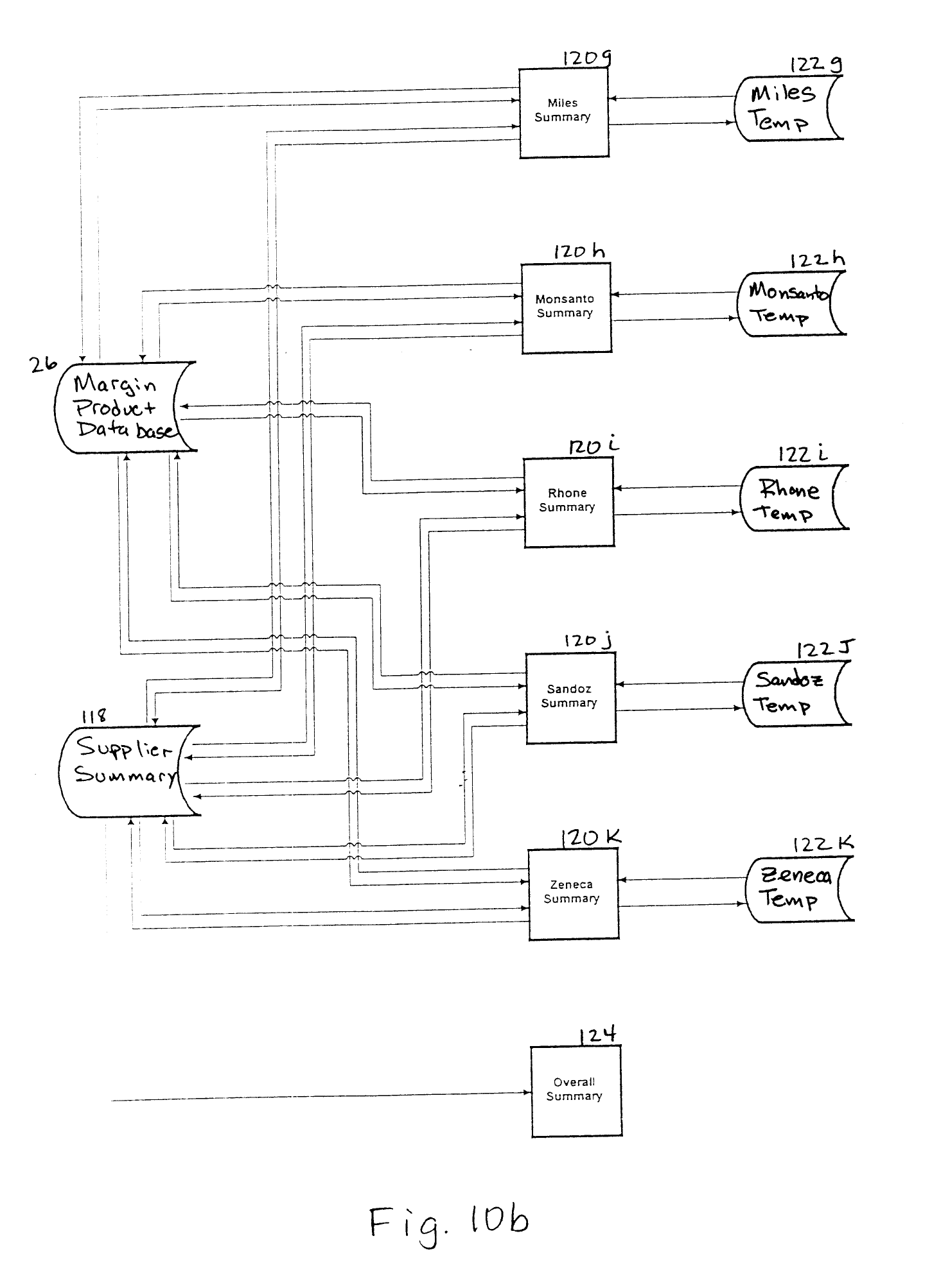

Data flow through the supplier summary module is shown in FIGS. 10a-10b. Supplier summary provides access to the summarized dealer program of each manufacturer of products within the main product records data base. 102a-102k. These manufacturer programs may be modified, updating the DECISION MAKER™ module's supplier summary 118 and margin product records data base 26 with all the changes made, or the changes to each supplier summary may be saved in a temporary files 122a-122k without updating the DECISION MAKER™ module's supplier summary 118 or margin product records data base 26.

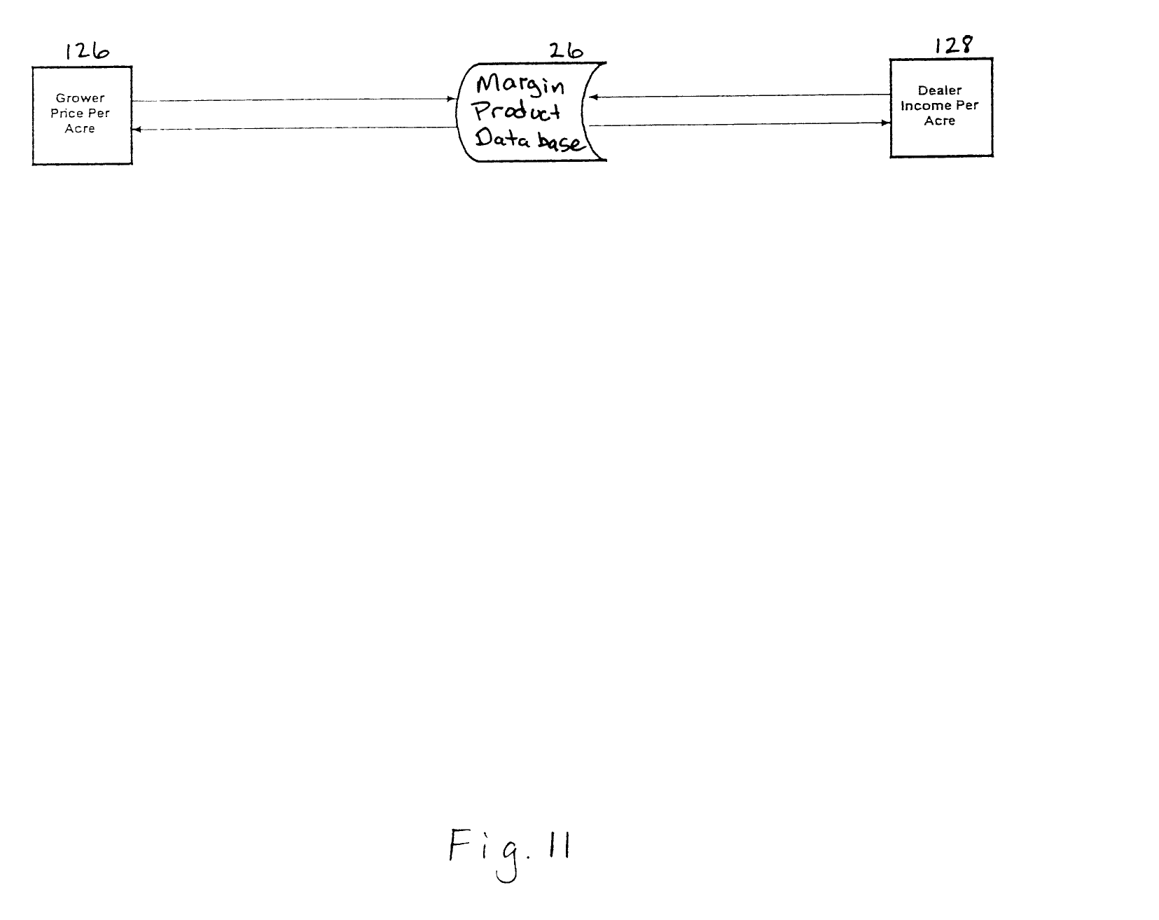

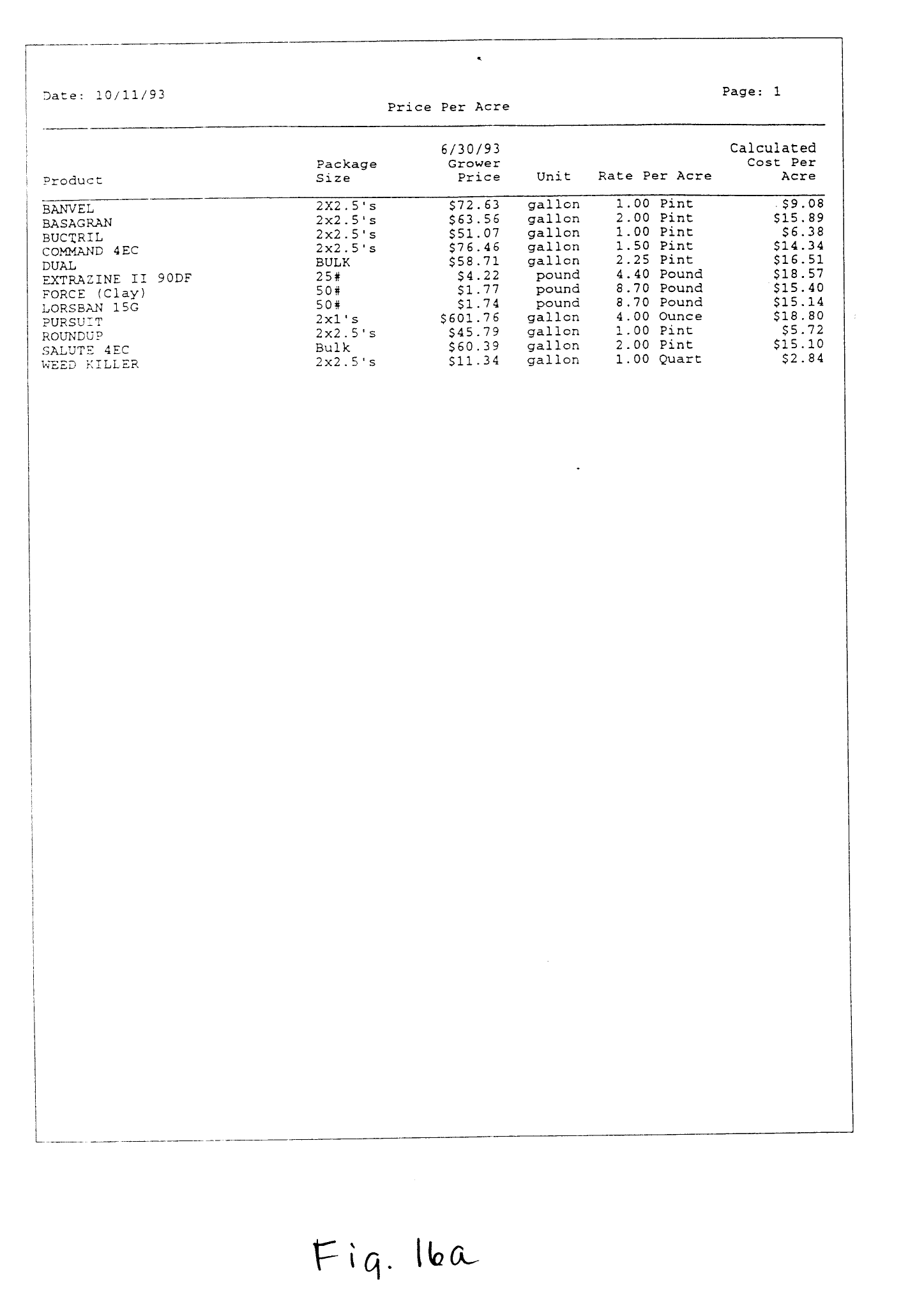

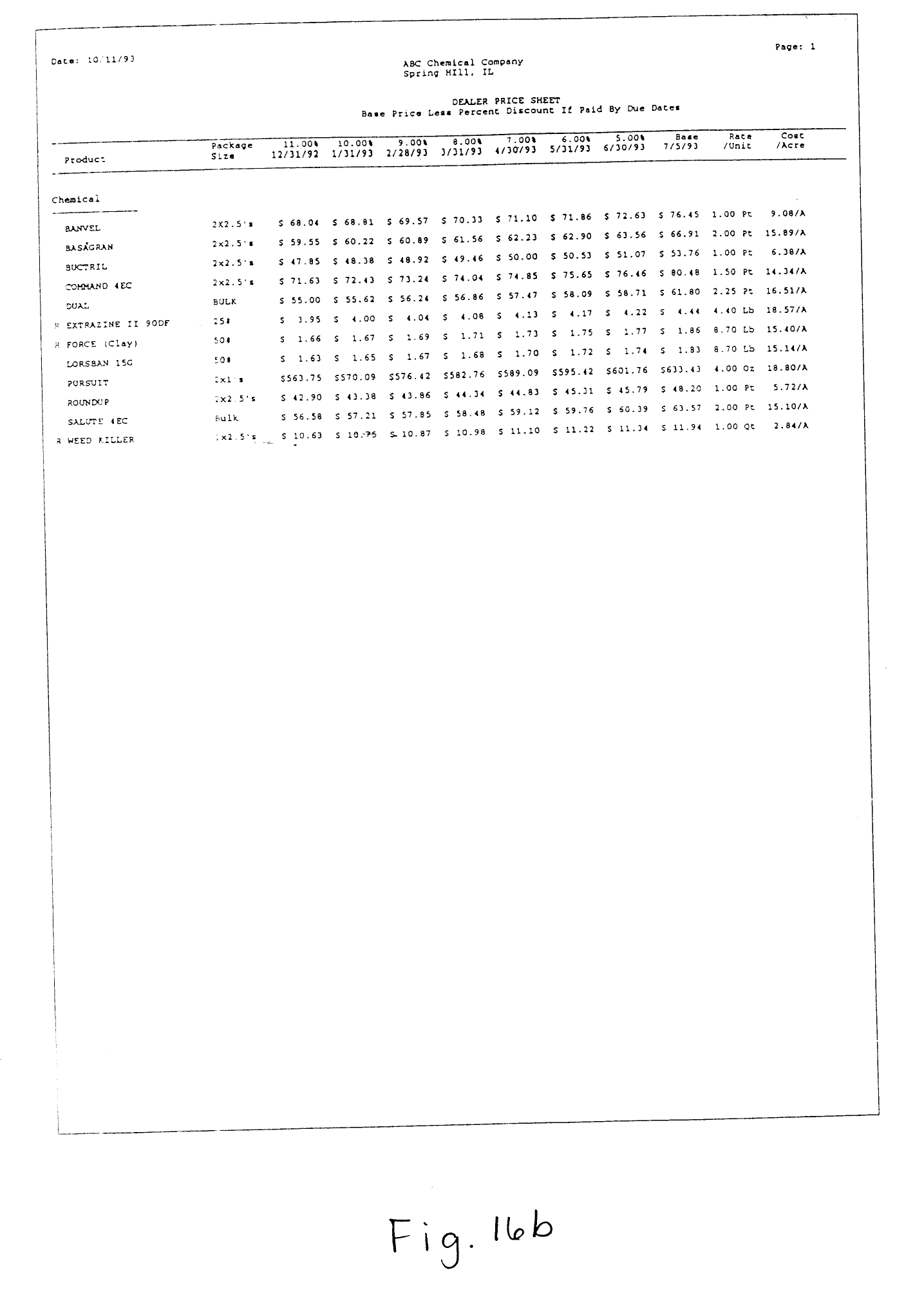

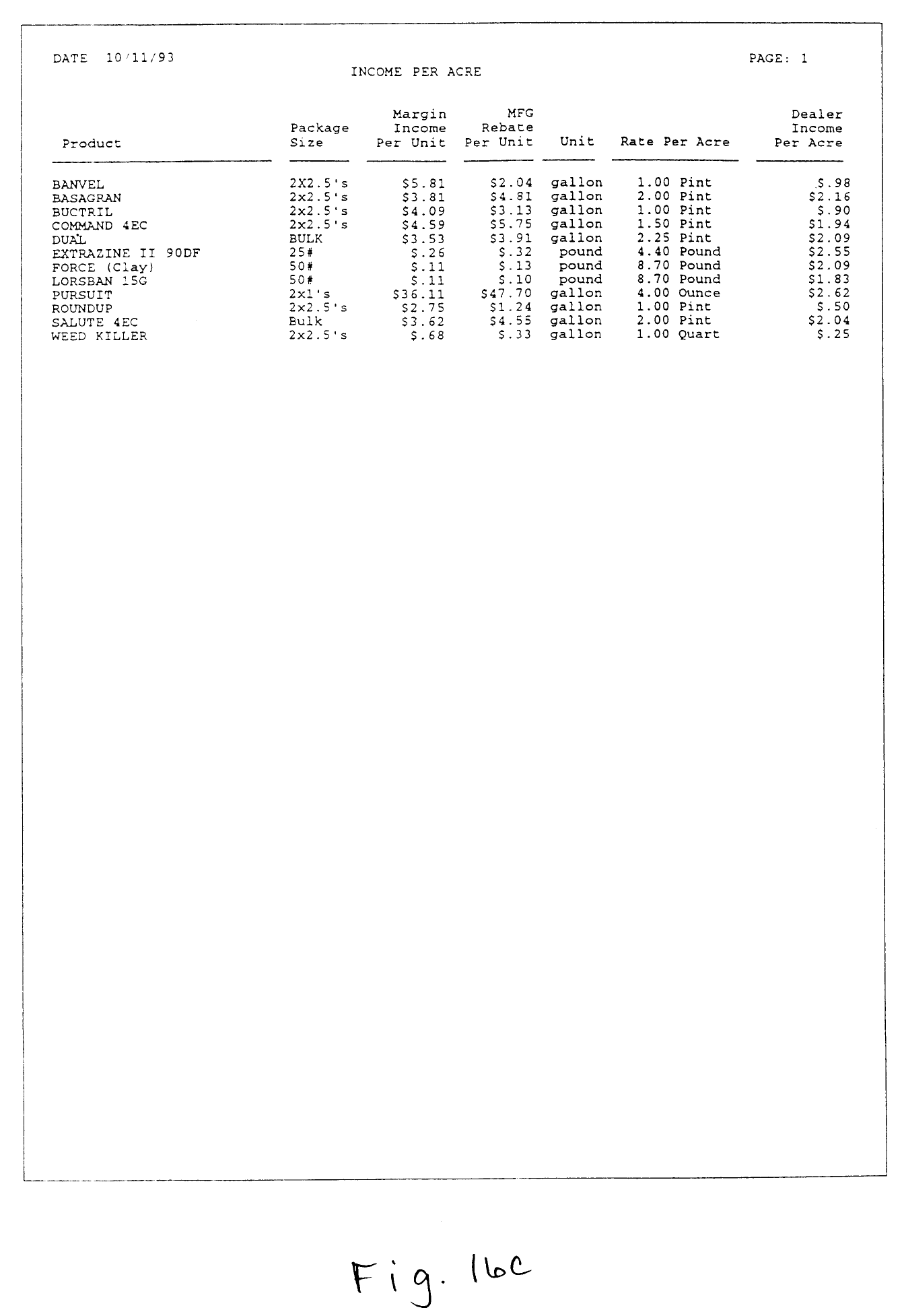

Data flow through the per acre summaries module 106, is shown in FIG. 11. The per acre summaries report option allows for the incorporation of price and cost of products sold on a per acre basis. The per acre summaries module provides for the display and printing of a price per acre report 126, and for the display and printing of an income per acre report 128. A sample of the price per acre and income per acre summary reports are shown in FIGS. 16a and 16b.

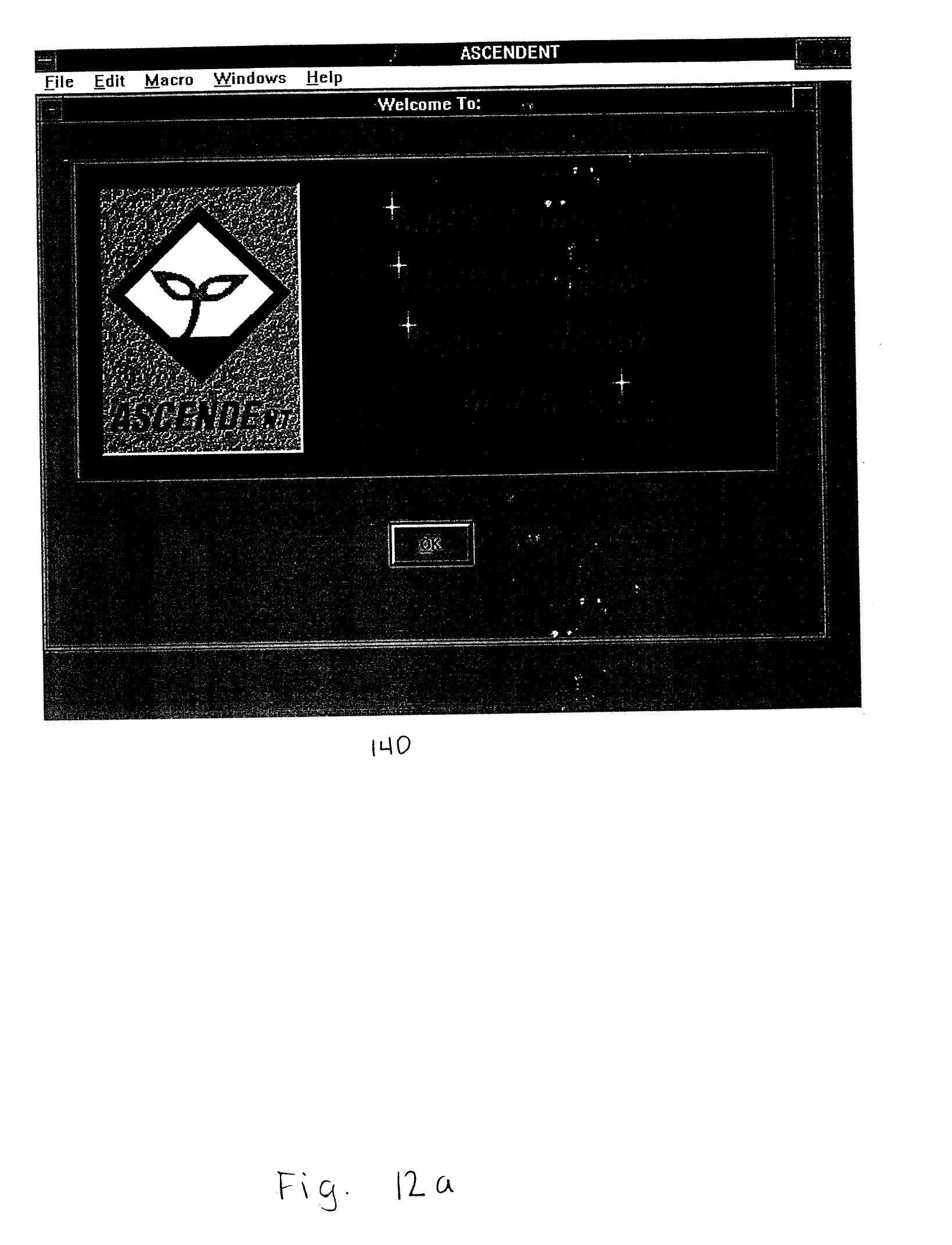

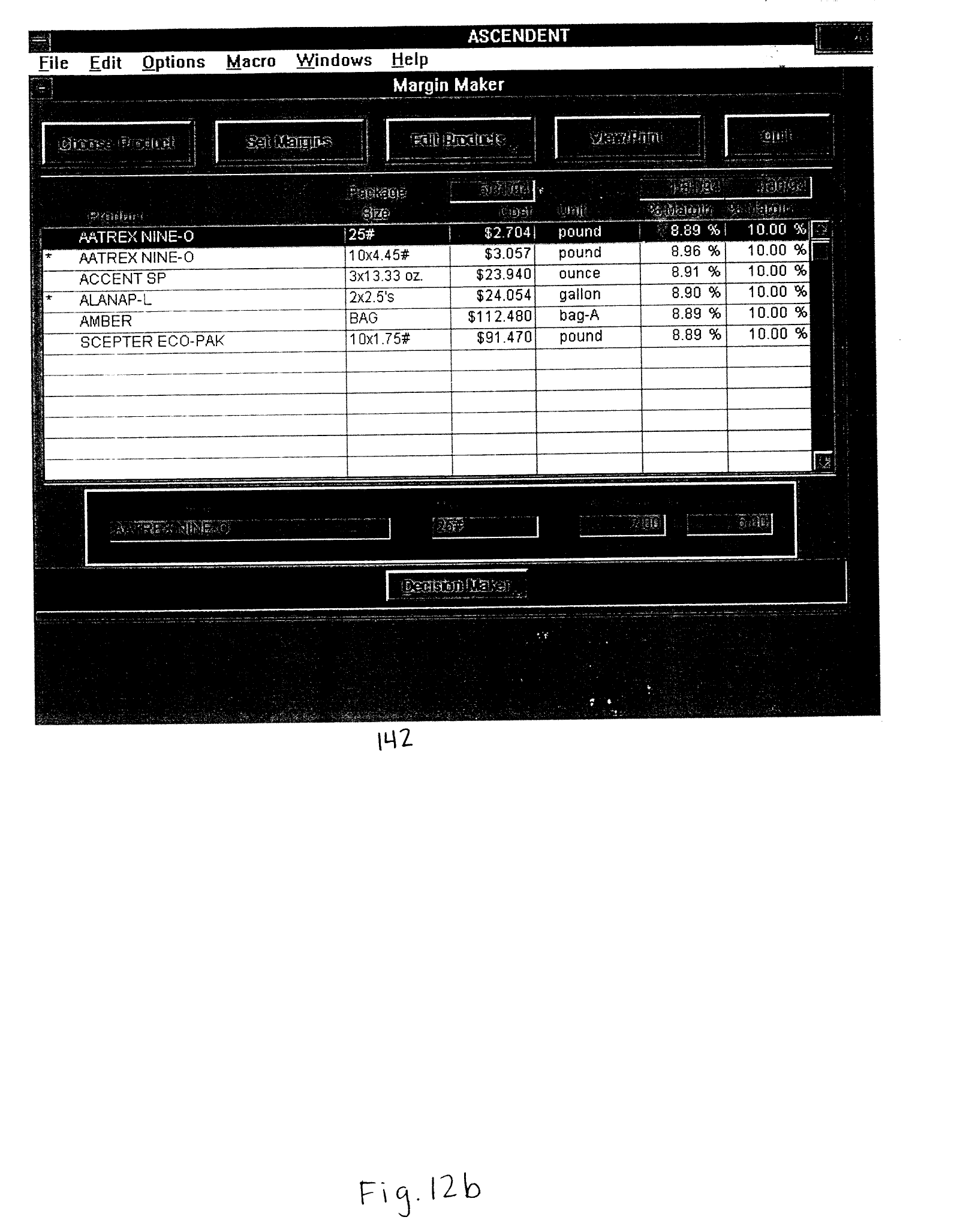

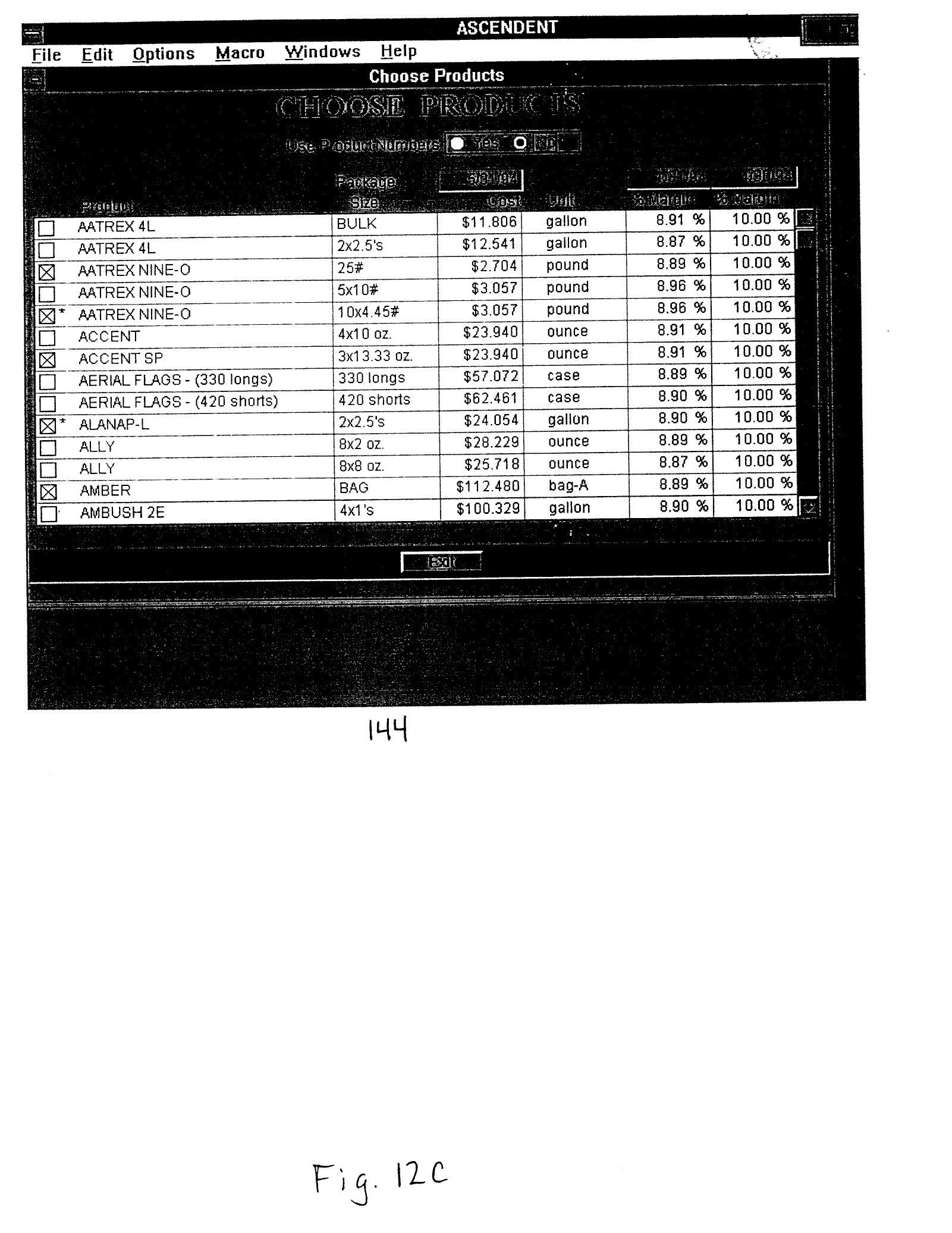

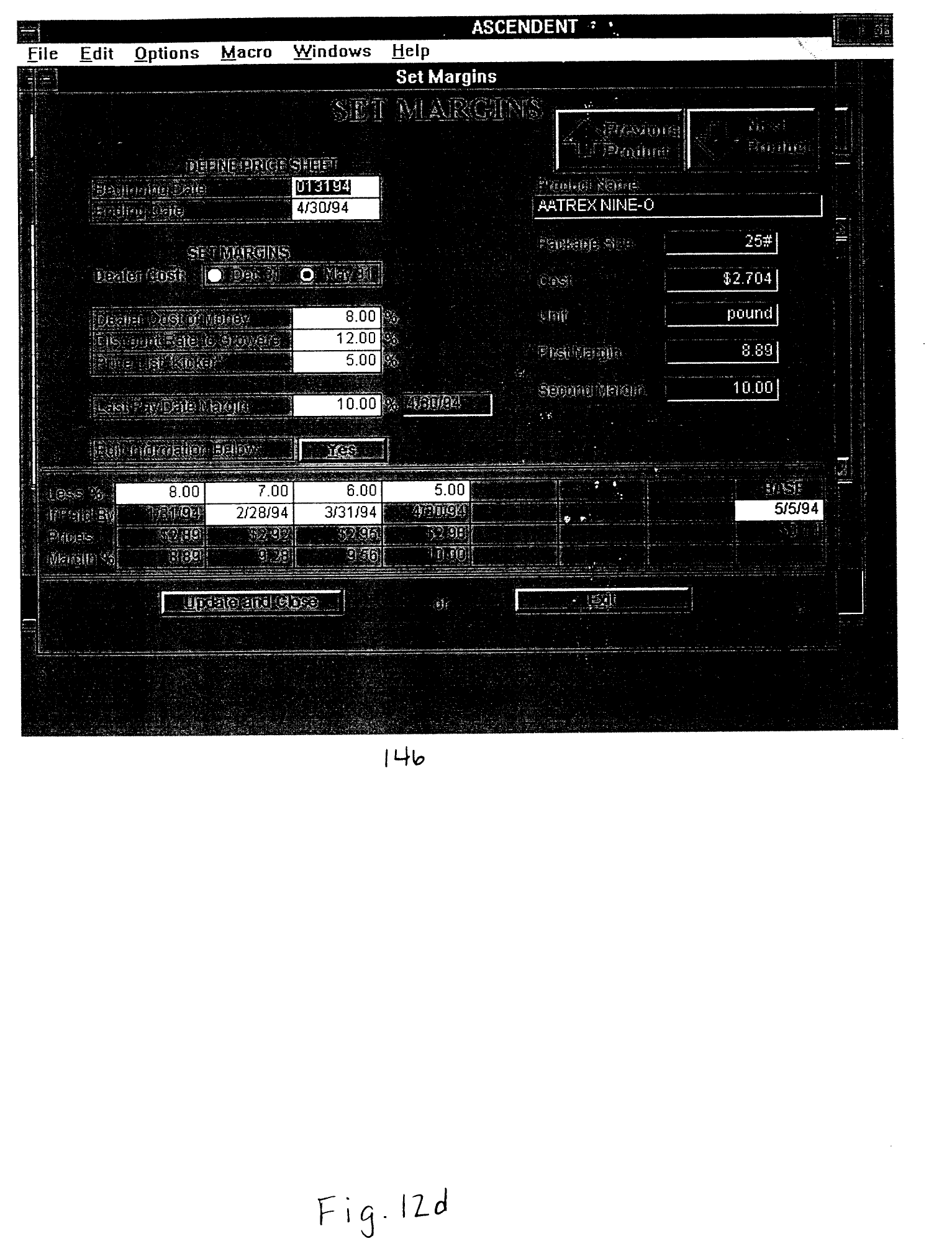

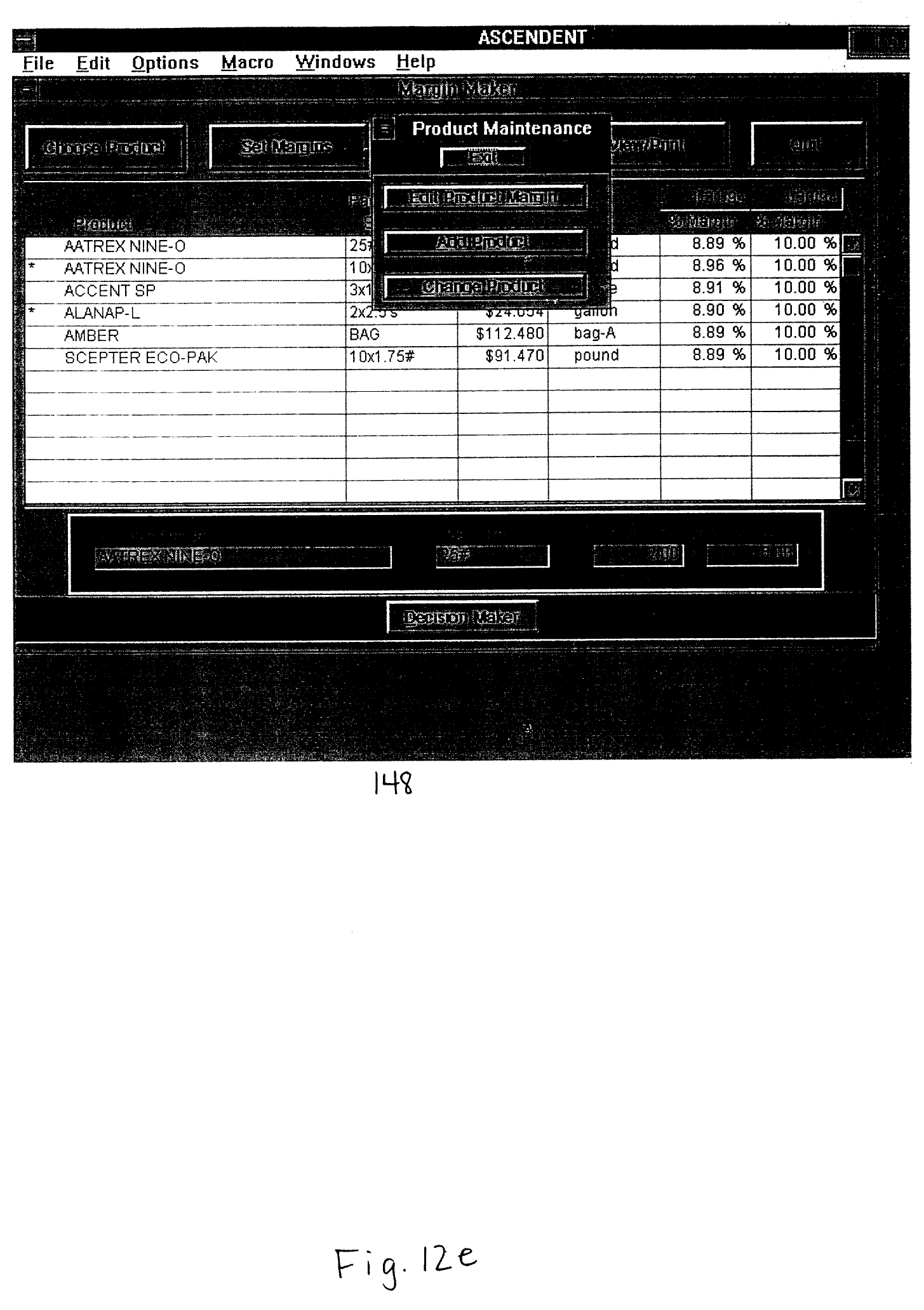

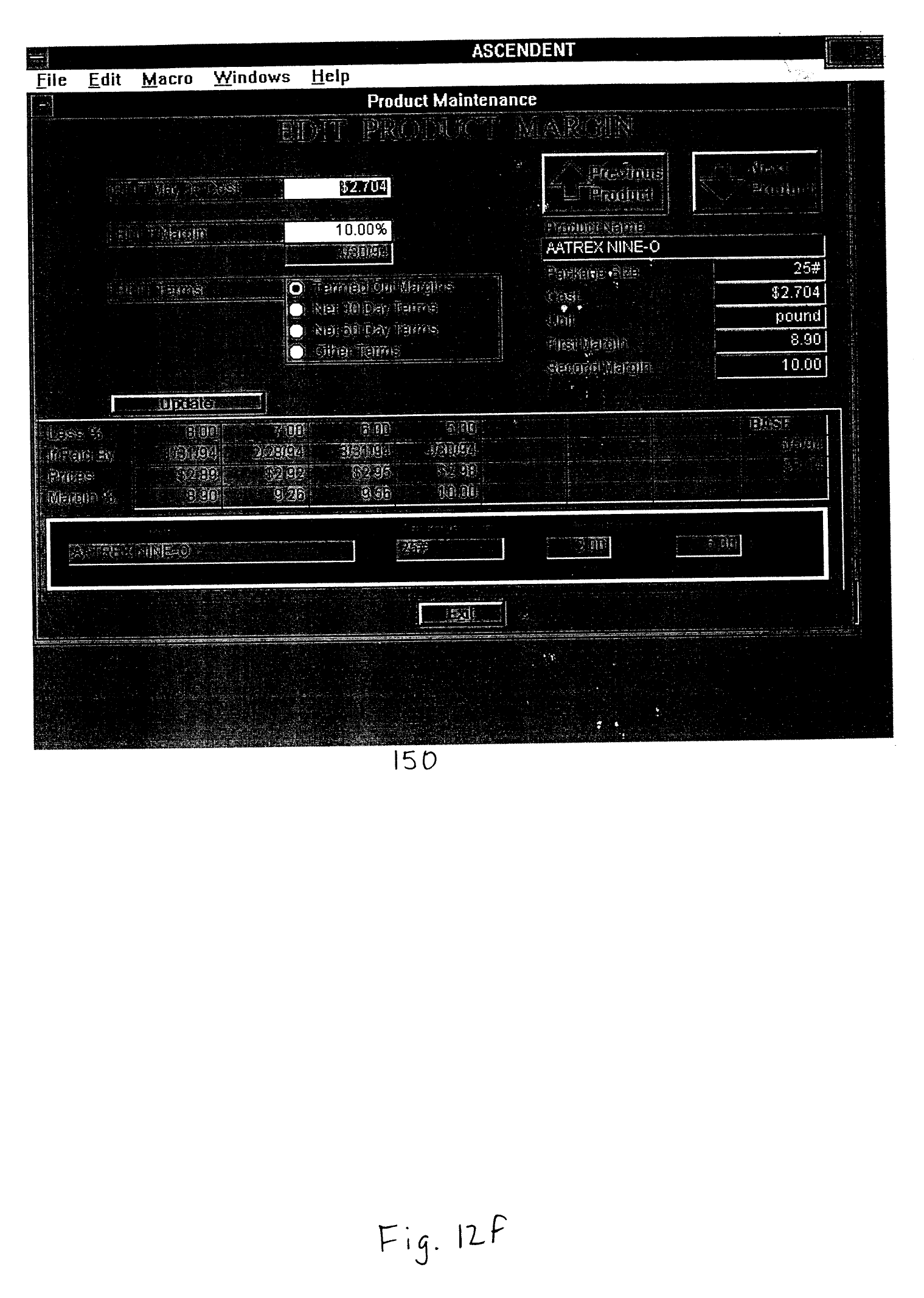

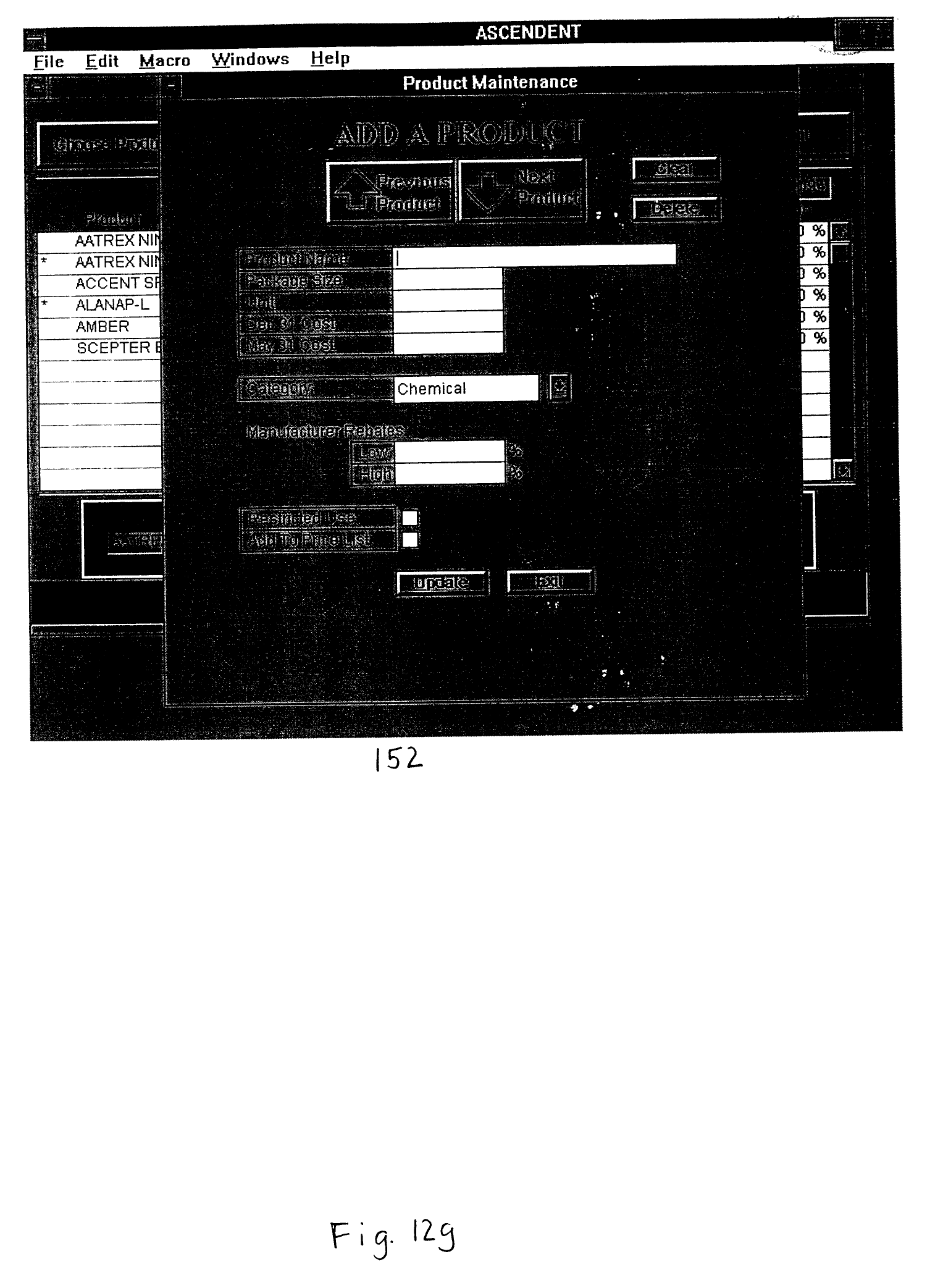

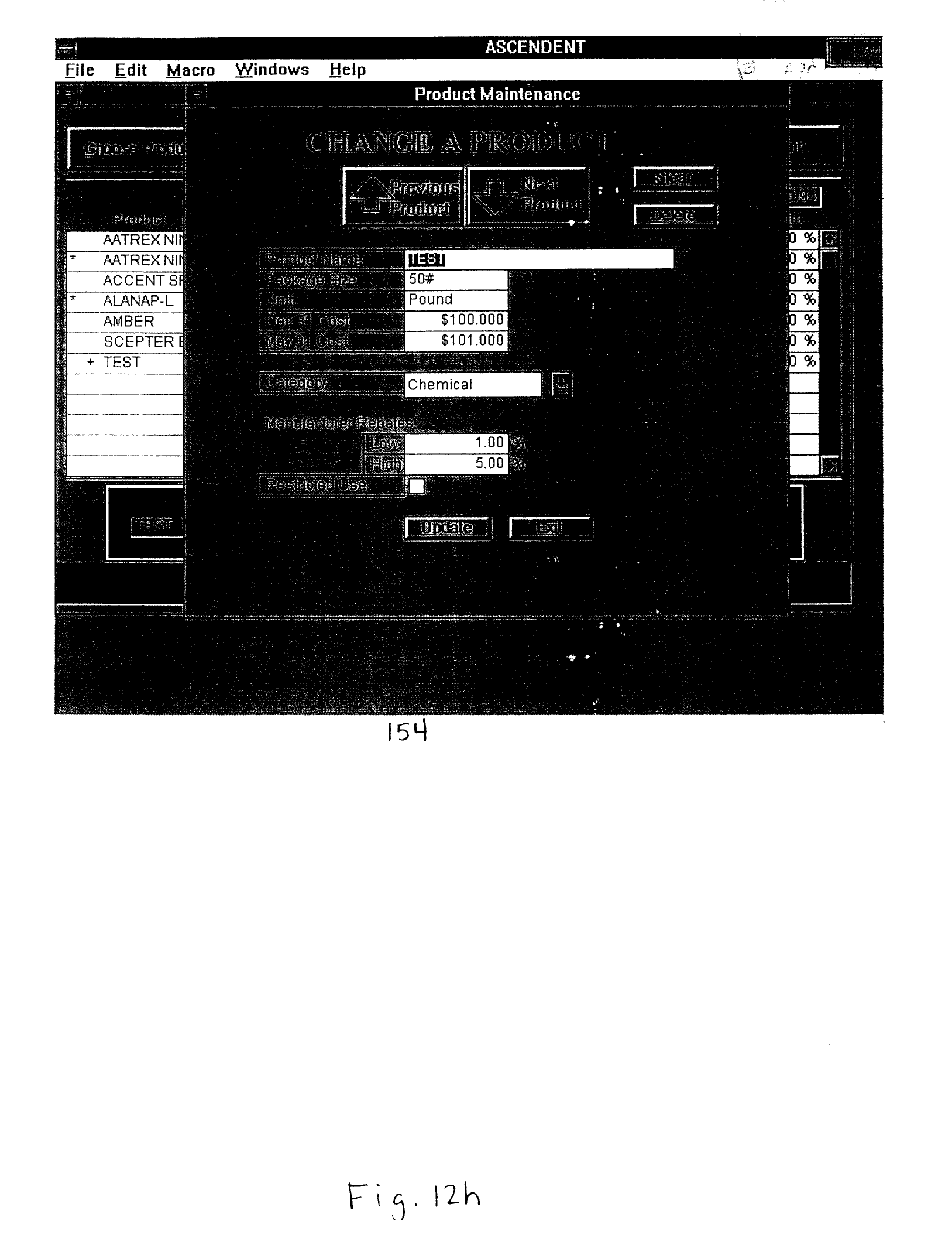

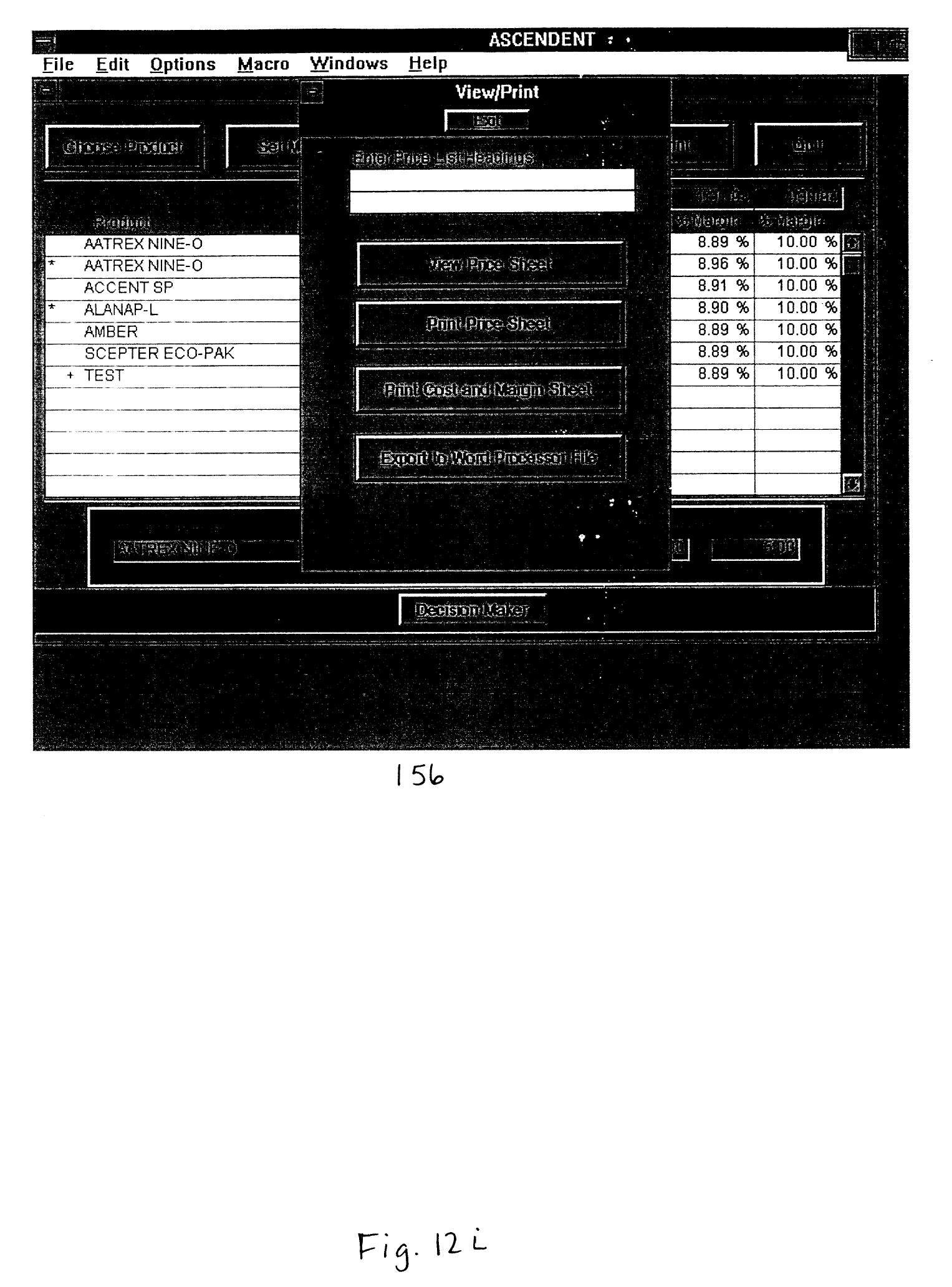

FIGS. 12a-12i are an illustration of the screens the preferred system 10 takes a user through when accessing the MARGIN MAKER™ module 20. It is to be understood that the margin determination and forecasting system is not to be limited to the preferred screens shown in FIGS. 12a-12i and that the system could have other screens and options accessing without departing from the scope of the present invention.

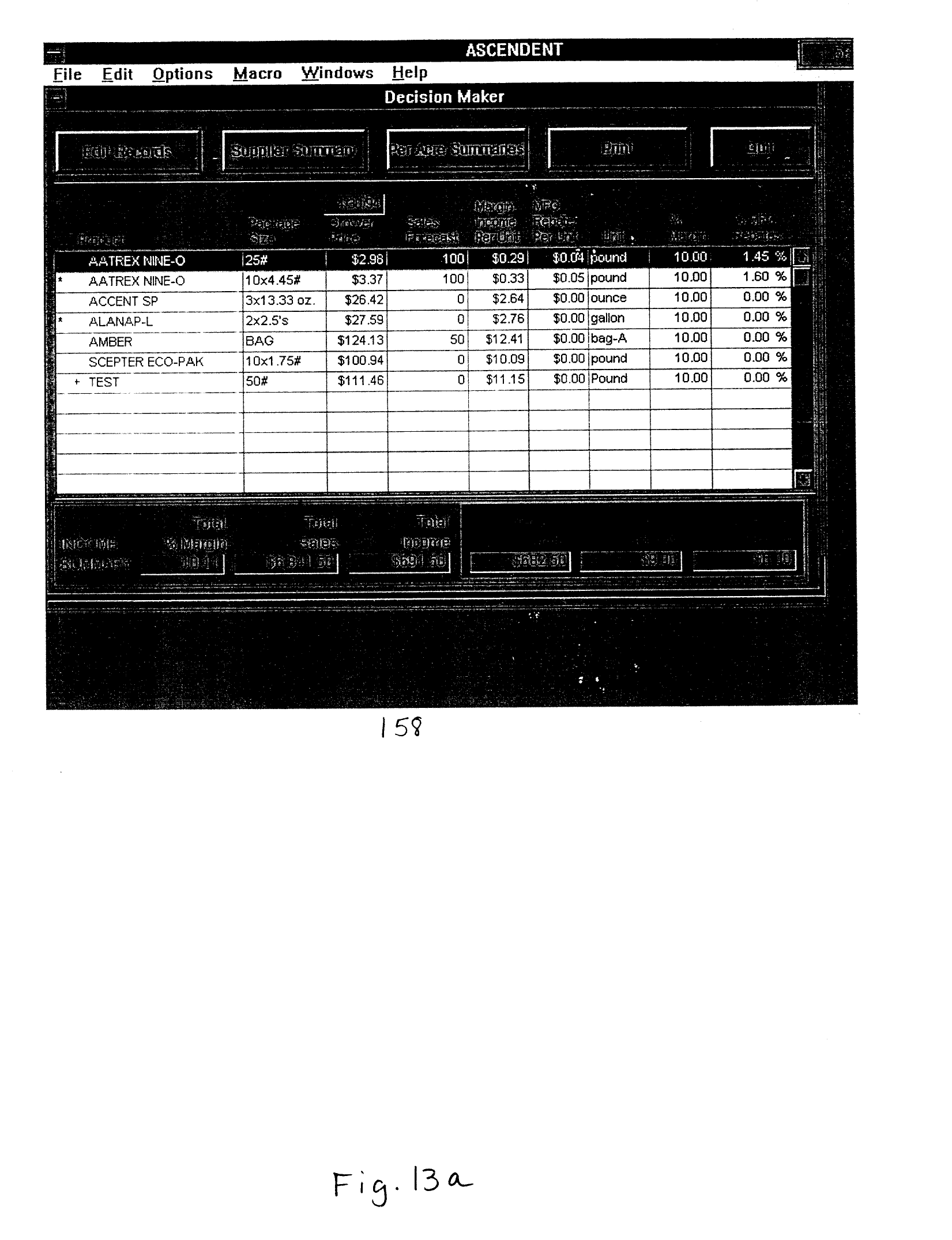

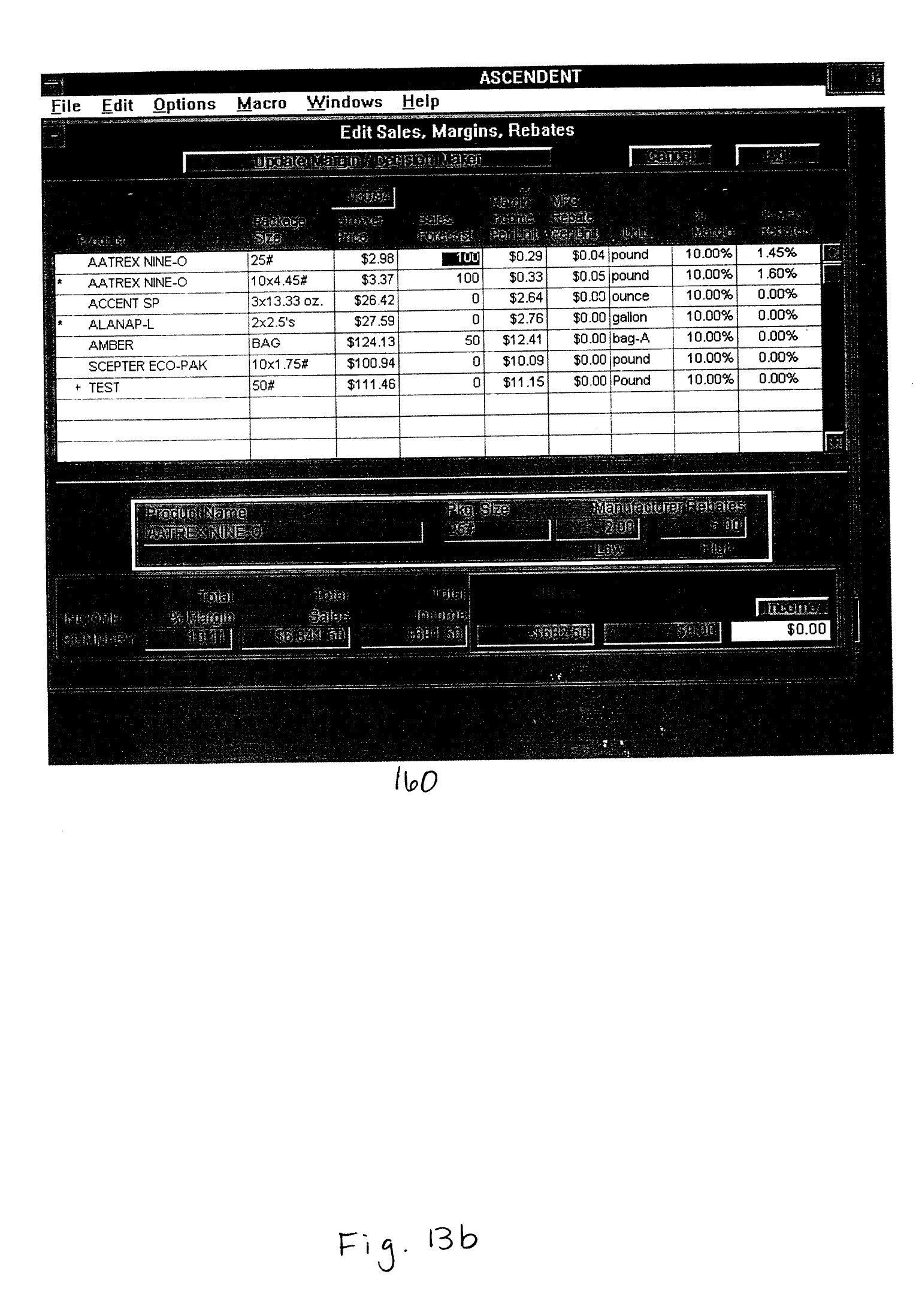

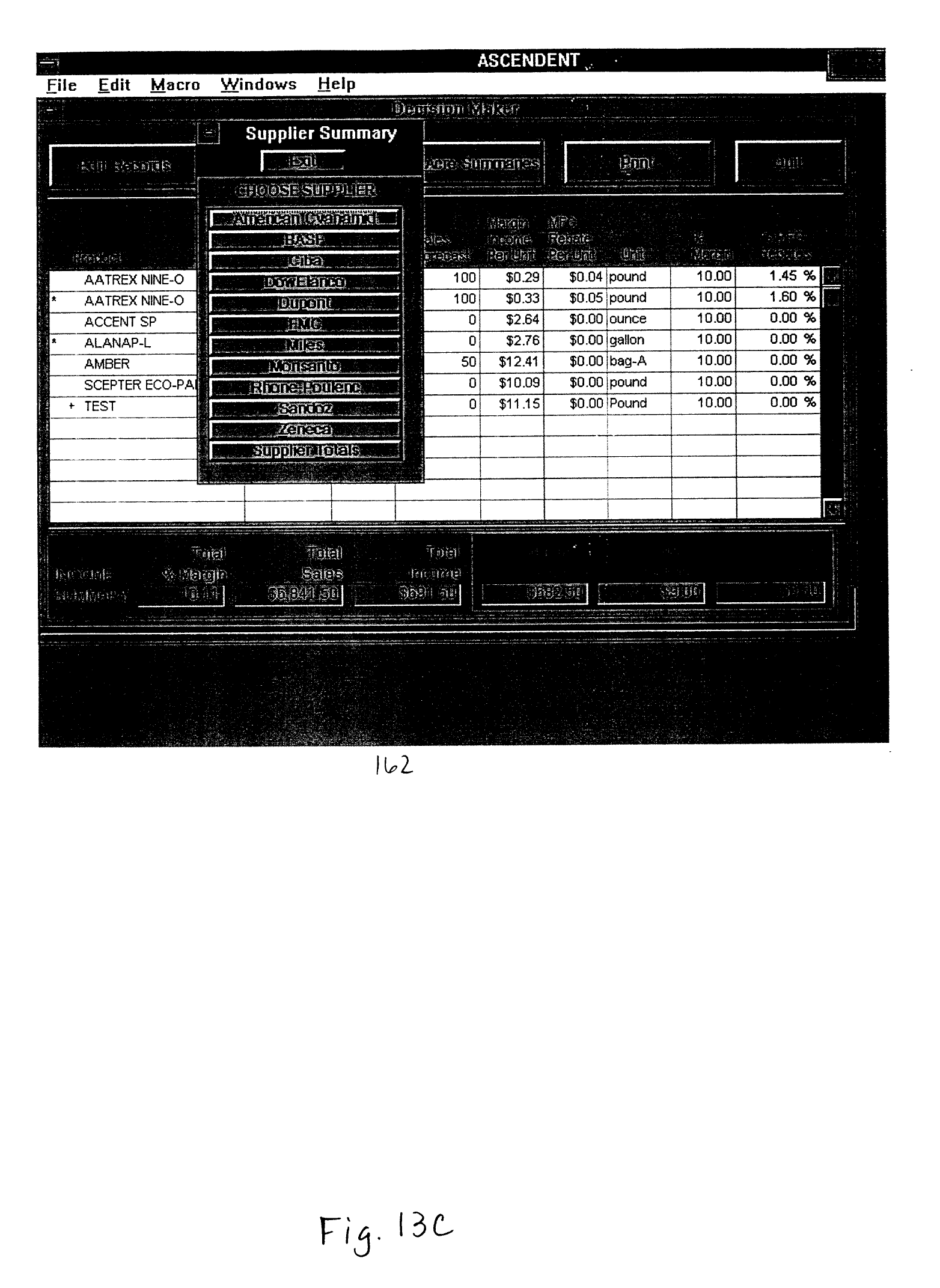

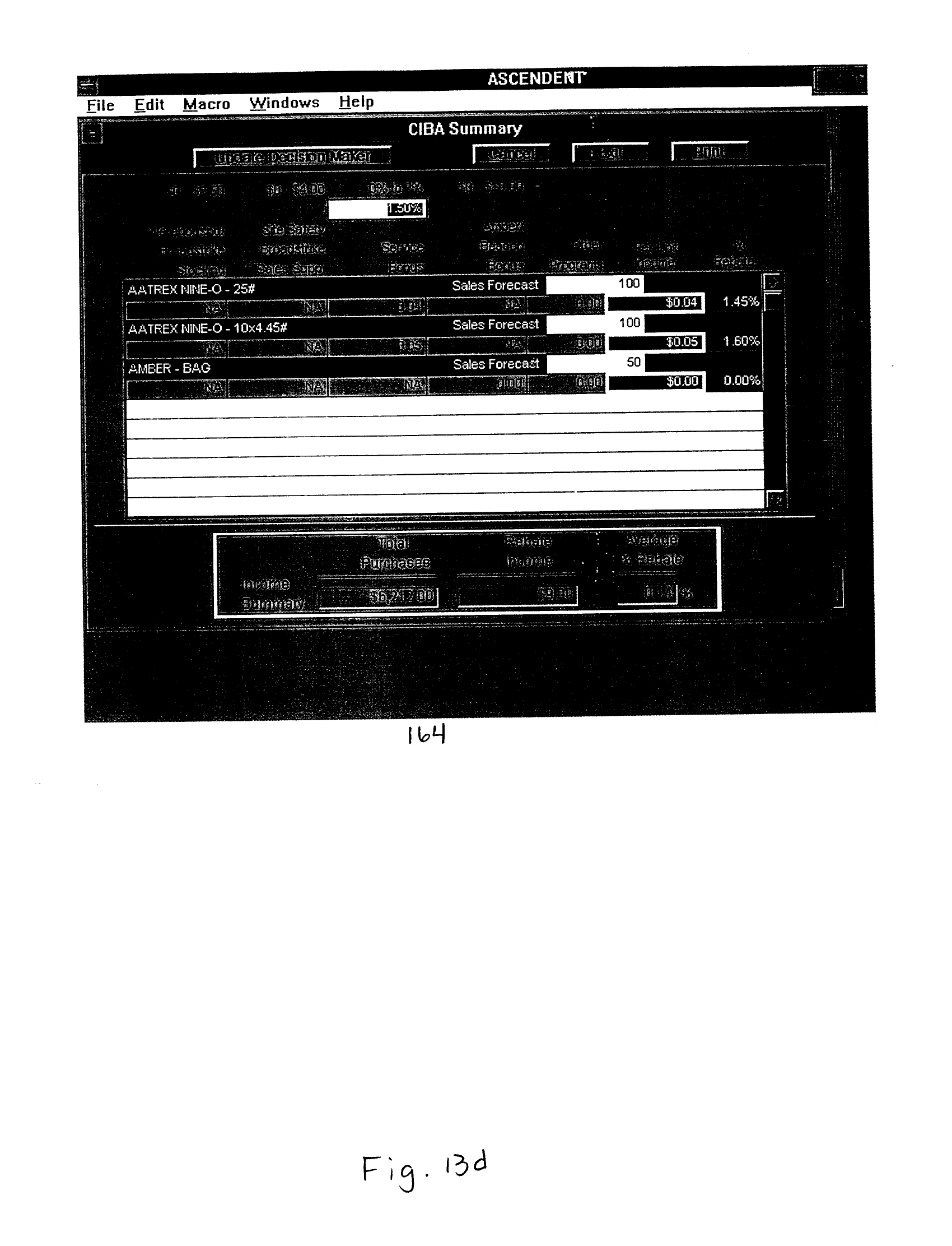

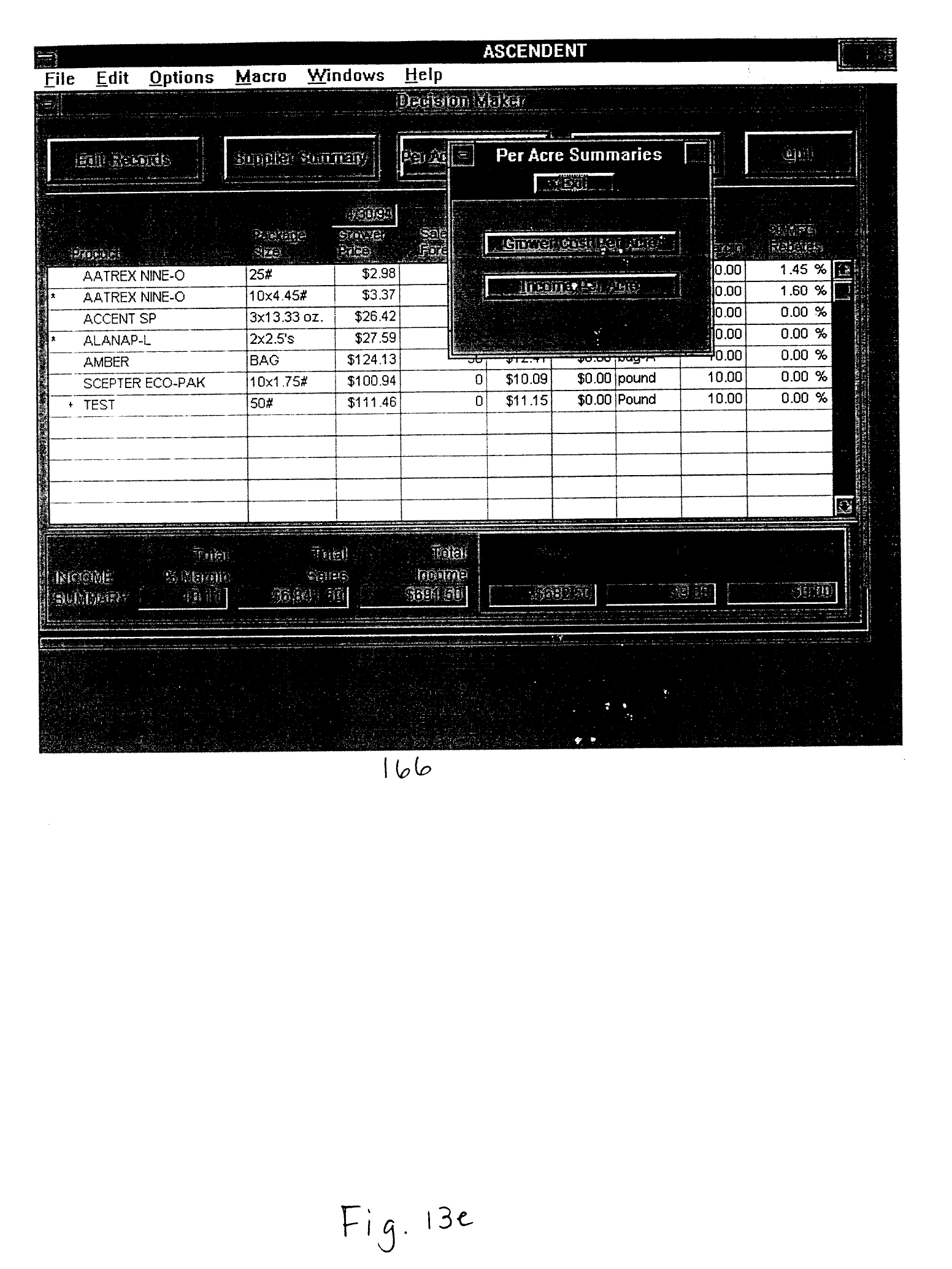

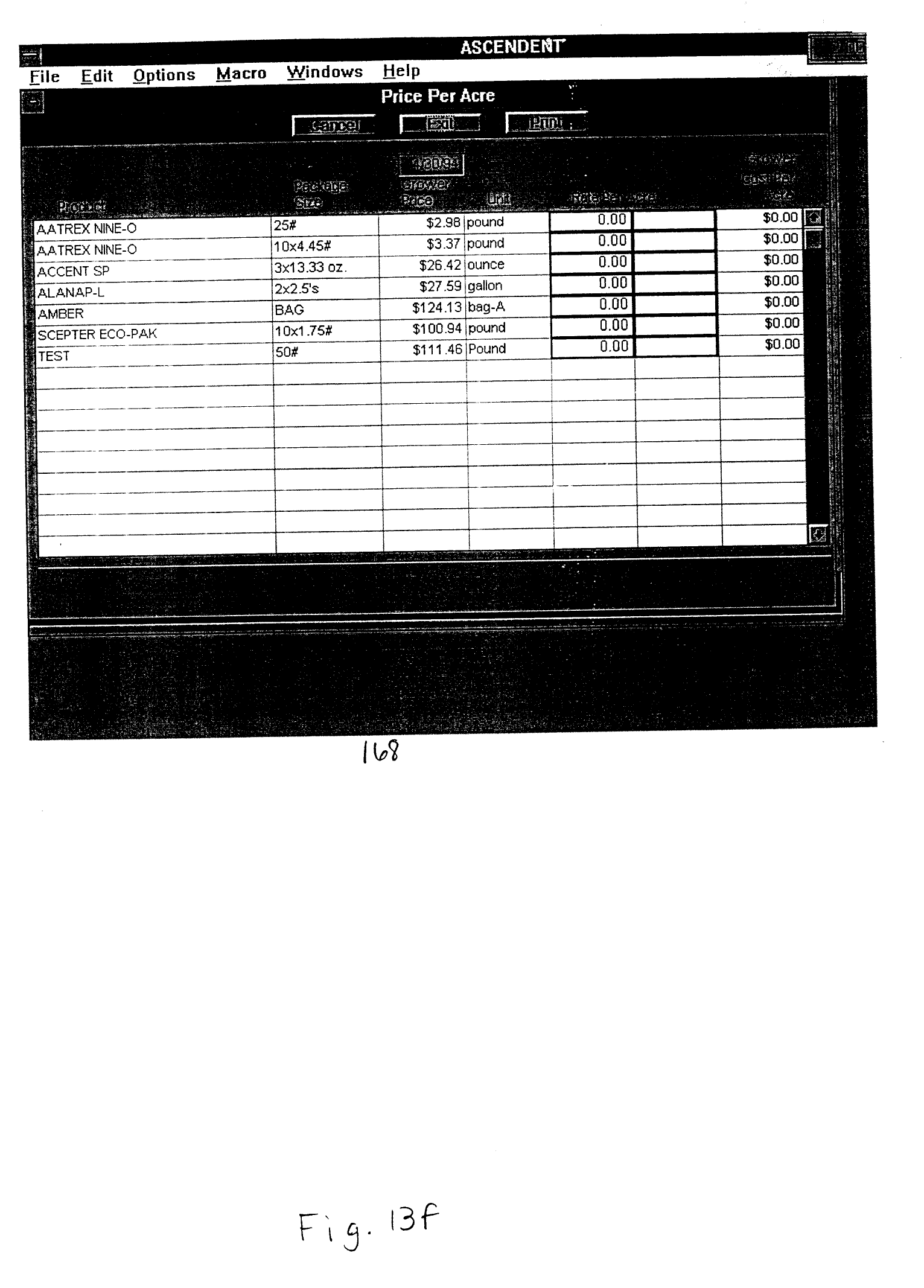

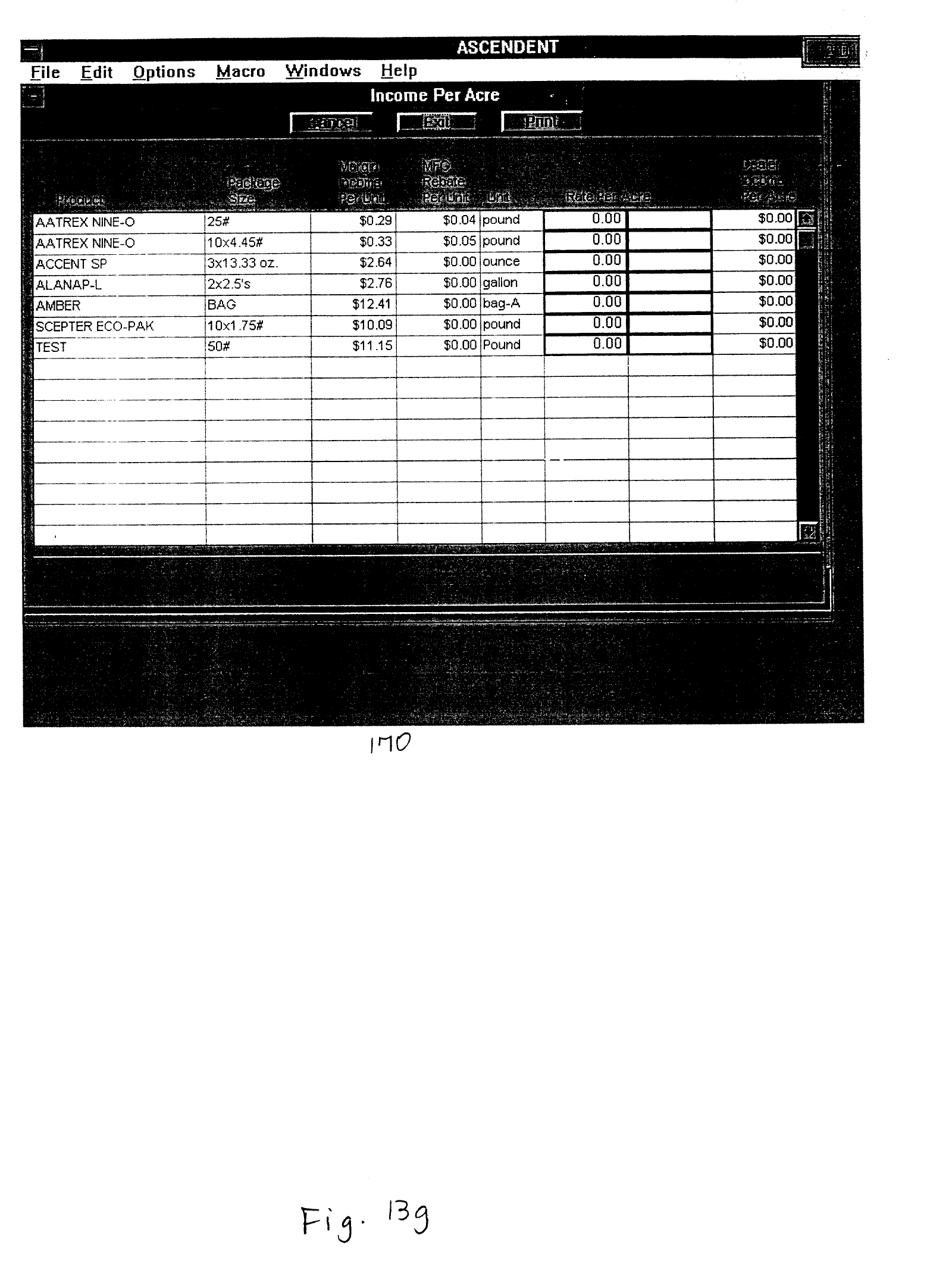

The first screen 140, shown in FIG. 12a, is what the user sees when accessing the system. FIG. 12b is an illustration of MARGIN MAKER™ module main menu 142. The MARGIN MAKER™ module main menu 142 also provides access to the DECISION MAKER™ module 22. The screens for DECISION MAKER™ module are illustrated in FIGS. 13a-13h.

The MARGIN MAKER™ module main menu 142, as shown in FIG. 12b, provides access to five functions within the MARGIN MAKER™ module: choose products, set margins, edit products, view/print and quit.

Engagement of the MARGIN MAKER™ module choose products function, illustrated in FIG. 12c as screen 144, provides access to the main product records database. The main product records database of the preferred embodiment lists all product records alphabetically in four categories, chemical, 4-D micro nutrient and fertilizer. At the choose products screen 144 the user may scroll through all of the product records within the main product records database, identifying records for products it anticipates selling during the selling period. The identification of records condenses the list of product records directly accessed in the MARGIN MAKER™ module to only those products the user anticipates selling. At the choose products screen 144 the user may also exercise the option of assigning product numbers to each product identified.

The MARGIN MAKER™ module set margin function screen 146 is shown in FIG. 12d. Set margins is normally used to establish the parameters of the user's price sheet and for setting a global margin for all of the products in the main product records database. Only products selected at choose products may be accessed in set margins. However, because margins are set for the entire main product records data base, through global margin set, a user can re-enter choose products and select additional products that will already be priced.

The set margins screen 146 has a number of fields for entry of data that define a price report to be generated. In the preferred embodiment, these fields include price sheet beginning date; price sheet ending date; dealer cost margin date; dealer cost of money percentage; discount rate to growers percentage; price list kicker (list price discount); and last pay date margin percentage. The system prompts the user through the entry of data at the appropriate labeled fields. After completion of data entry, the system typically determines the margin income and price data and displays it in the defined fields within the pricing box at the bottom of the set margins screen 12d.

The price sheet beginning and ending dates define the selling period.

There is a choice of two cost dates, December 31, or May 31. The cost of money is an amount by which the product price is adjusted to reflect the time value of money borrowed at the current rate. This is done so that a true reflection of the anticipated margin can be determined. Depending on the current month, and the cost date chosen, the cost of money will be worked forward or backward until the period is termed out.

The discount rate to growers percentage is an annual percentage rate type of discount.

The price list kicker defines a percentage discount for the last pay date. It is the final discount the seller has chosen to give all buyers on all products purchased on the last pay date.

The last pay date margin is the margin received on products sold on the last pay date.

FIG. 12d shows an example of set margins having all the data entry fields completed. FIG. 12d shows selling period beginning and ending dates of Jan. 31, 1994 and Apr. 30, 1994. The dealer cost margin was set at May 31. The dealer cost of money was set at 8%, the discount rate to growers at 12%, and the price list kicker at 5%. The last pay date margin has already been set at 10% and as such, when the price ($2.98) is determined, it will reflect the 10% margin from the base price ($3.14). Because the discount rate to growers is 12% on an annual basis, the percentage discount increases by 1% for each month. As the percentage discount rate increases, the price goes down and so does the margin percentage. This method of allowing real time margin forecasting allows a seller to determine the margin desired for the product sold on the last margin pay date, while at the same time providing incentives through discount rates and price list kickers without letting those incentives override the margin/profits. The value in this system is that it allows the user to view these prices for a selling period in real time to determine if margins set or discount incentives are unrealistic thereby causing losses. The user can modify the margin and/or discount incentives allowing for the generation of a pricing list in which all of the above factors are incorporated.

The system also allows for the editing of the pricing box, shown near the bottom of FIG. 12d. The discounts, base price and pay dates are edited for purposes of customizing the prices and margins desired. Following customization of the pricing information all products in the main products records database are priced. The system then returns to the MARGIN MAKER™ module main screen 142, shown in FIG. 12b.

The MARGIN MAKER™ module main screen 142 provides for the selection of the edit products function. Selection of edit products yields screen 148 shown in FIG. 12e. As shown in FIG. 12e, the edit products screen 148 provides the option to engage the following functions: edit product margin, add product and change product.

The edit products margin screen 150 shown in FIG. 12f allows the user to edit an individual product's cost, margin and terms. The affects such modifications have on the pricing report can be seen in the pricing box upon updating the changes. The manufacturer rebate control data is displayed at the bottom of the edit products screen 150 along with the package size and product name.

The add products screen 152 shown in FIG. 12g, allows the user to add product records the seller would like to include in MARGIN MAKER™ module. These would be product records for products not found in the main product records database. The system automatically adds the product records entered at screen 152 into the MARGIN MAKER™ module by inserting the products into the main product records data base and margin product records data base. These products would be added alphabetically by category. The system also allows for the creation of additional categories for these products. The added products will also be priced at the global margin and terms selected in the set margins screen 146.

The change products screen 154, shown in FIG. 12h allows the user to change product records added to the main product records data base by the user. The product records in the original main product records database may be edited but not changed.

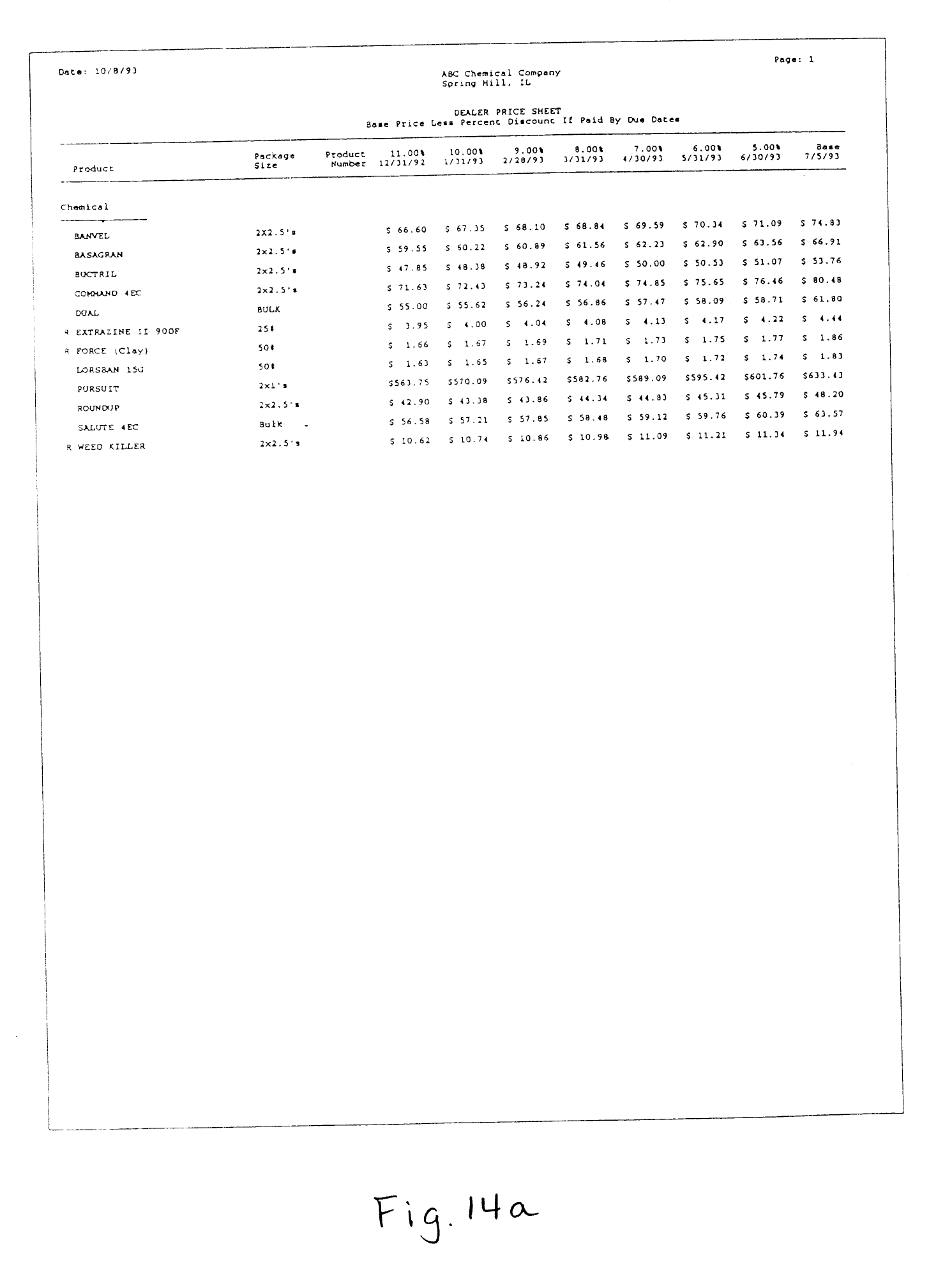

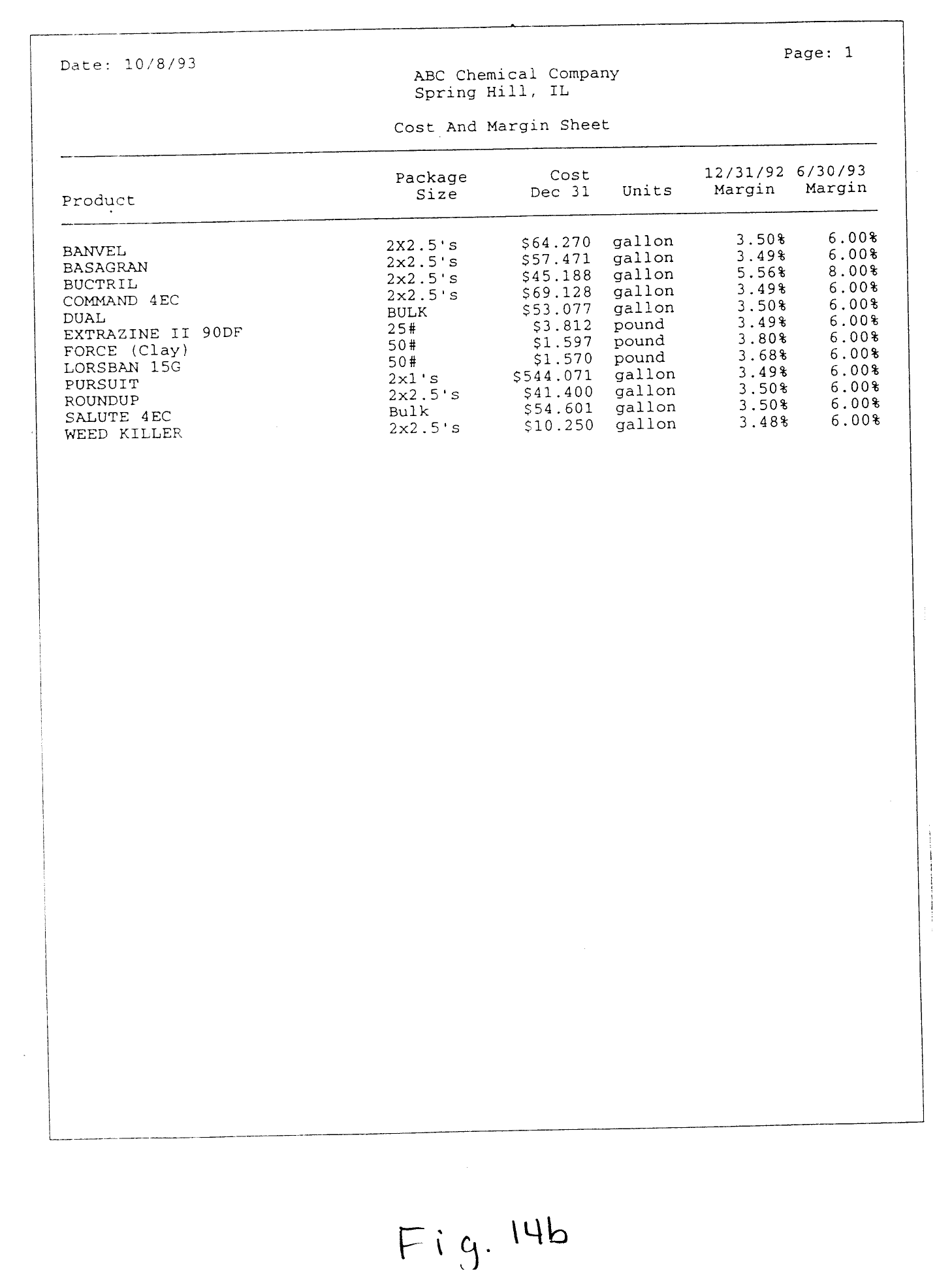

Selection of the view/print function at the MARGIN MAKER™ module main screen 142 generates view/print screen 156 shown in FIG. 12i. The view/print screen 156 allows the user to view the price report before printing, print the price report, print a cost and margin report and transfer the printed reports to a word processing file. A sample price report is shown in FIG. 14a. A sample cost and margin report is shown in FIG. 14b.

The DECISION MAKER™ module is activated from the MARGIN MAKER™ module main screen 142, shown in FIG. 12b. The DECISION MAKER™ module main screen 158 is shown in FIG. 13a. It displays for each product within the margin product records database the last discounted grower price; sales forecasts; margin income on last discounted grower price per unit; manufacturer rebate per unit; last pay date margin percentage; and manufacturer rebate percentage. It also displays totals of: margin income, manufacturer income, additional income, total income, total sales, and total percentage margin. These totals define the user's income summary.

The DECISION MAKER™ module main screen 158 allows the user to engage the following functions: edit records; supplier summaries; per acre summary; and print.

The edit records screen 160 as shown in FIG. 13b allows the user to enter anticipated sales forecast variables, manufacturer rebate percentage and last pay date margin percentage. Edit records screen 160 also displays for each product listed in the main product records database the package size, last discounted grower price, the margin income on last discounted grower price, sales forecast variables, margin income per unit, manufacturer rebate income, last pay date margin and manufacturer rebate percentage. Edit records screen 160 also displays totals for margin income, manufacturer rebate income, additional income, total income, total sales, and total percentage margin.

Selection of the DECISION MAKER™ module supplier summary, shown in FIG. 13c as screen 162, provides for the selection of one of the manufacturers within the list of manufacturers providing products listed in the main product records data base.

Selection of one of the list of manufacturers within supplier summary, for example CIBA as shown in FIG. 13d provides a supplier summary screen 164 detailing the selected manufacturer's dealer program. Screen 164 provides the ability to plan in advance each manufacturer's rebate income and for a determination of the actual rebate for each manufacturer. As FIG. 13d shows, each manufacturer has its own supplier summary screen detailing all of the elements of its programs. Screen 164 details by product each dealer program, sales forecast variables, rebate income per unit by program, total rebate income per unit, percentage rebate per unit, and it displays the totals of purchases, rebate income and average percentage rebate.

Each individual supplier total screen summarizes a manufacturer's total purchases, rebate income, and average percent rebate. The accuracy of each supplier summary screen can be maximized by consulting with each manufacturer's representative while going through that company's programs. A manufacturer dealer program summaries programs that are published annually and may provide details on each product's dealer program.

The information entered at the supplier summary screen 164 overrides information entered in the edit records screen 160, shown in FIG. 13b. Only the sales forecasts data is transferred into the supplier summary screens from the DECISION MAKER™ module.

Within supplier summary there is also the ability to display supplier summary totals. This screen, not shown, displays the manufacturers in alphabetical order showing each manufacturer's total purchases, rebate income and average percentage rebate in columnar form. The totals of these columns would be at the bottom of the screen.

Supplier summary screen 164 and the supplier summary total screen (not shown) provide for the printing of a report of these screens upon selection of that option.

The per acre summary function within the DECISION MAKER™ module allows for the incorporation of price and cost on a per acre basis. FIG. 13e is illustrative of a selection of the per acre function within the DECISION MAKER™ module. As shown in FIG. 13e, there are typically two per acre summary options, grower price per acre and an income per acre, shown as screen 166. The per acre summary screens allow for entry of product rates and a determination for each product the grower's cost and the seller's income per acre. There are normally two per acre summary screens, grower cost per acre, shown as screen 168 in FIG. 13f and income per acre, shown as screen 170 in FIG. 13g. At either of these screens, the rate desired for each product may be entered and those rates are automatically transferred from one screen to the other. The price per acre screen 168 shown as FIG. 13f provides fields for the entry of a rate by which each product within margin product records data base is anticipated being sold per acre. Upon entry of a rate by which a particular product will be sold per acre, a select per acre unit screen appears to define the units by which each product is sold. The options for units are determined by whether the product is a liquid, dry or other material in a bag or packet. The per acre summary screen also allows for the price per acre report to be printed or for the data to be exported to a word processor file.

The income price per acre screen 170 as shown in FIG. 13g mirrors the grower price per acre screen 168. The previously entered rates at the grower cost per acre screen 168 are automatically transferred to the income price per acre screen 170 by the system. The income price per acre screen 170 provides a method for calculating the dealer's income or potential income per acre based on the dealer's selling price and the rate each product may be applied per acre. This is extremely important because the dealer can determine which product to push in its sales to make better profits based on the price and quantity sold, determined by the application per acre. FIGS. a 16a and 16b are samples of a price per acre report and a grower cost per acre price report. FIG. 16c is a sample of a income per acre report.

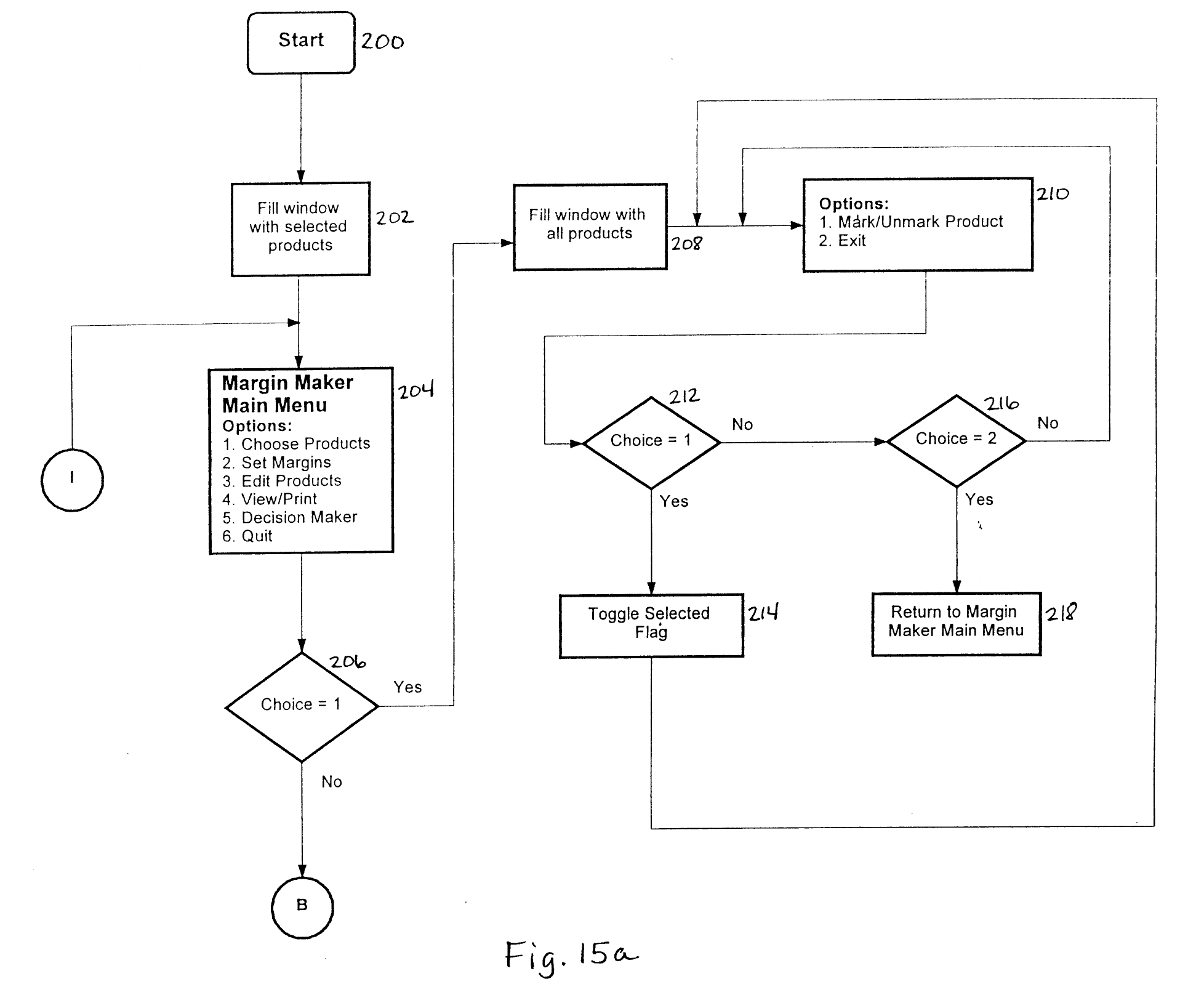

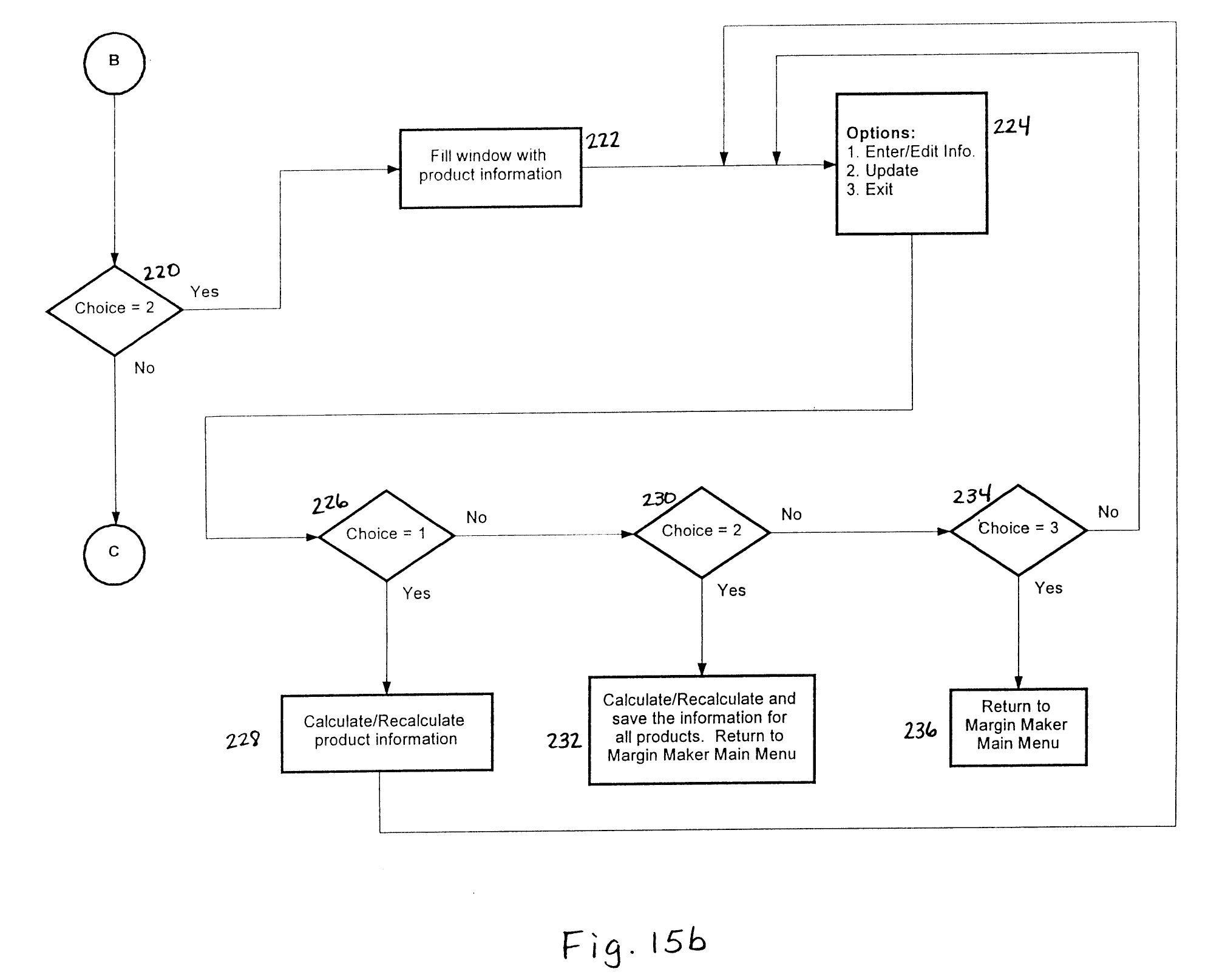

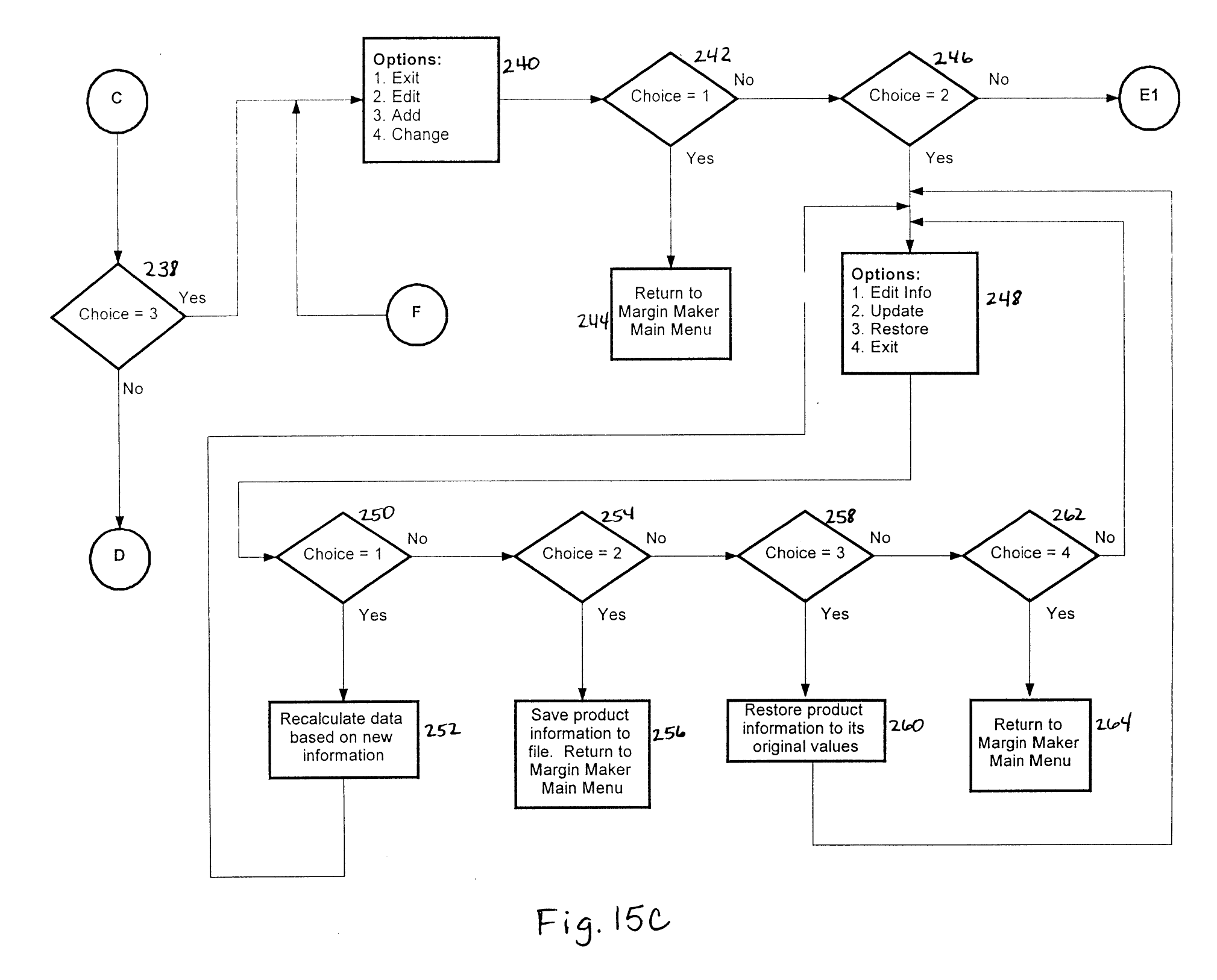

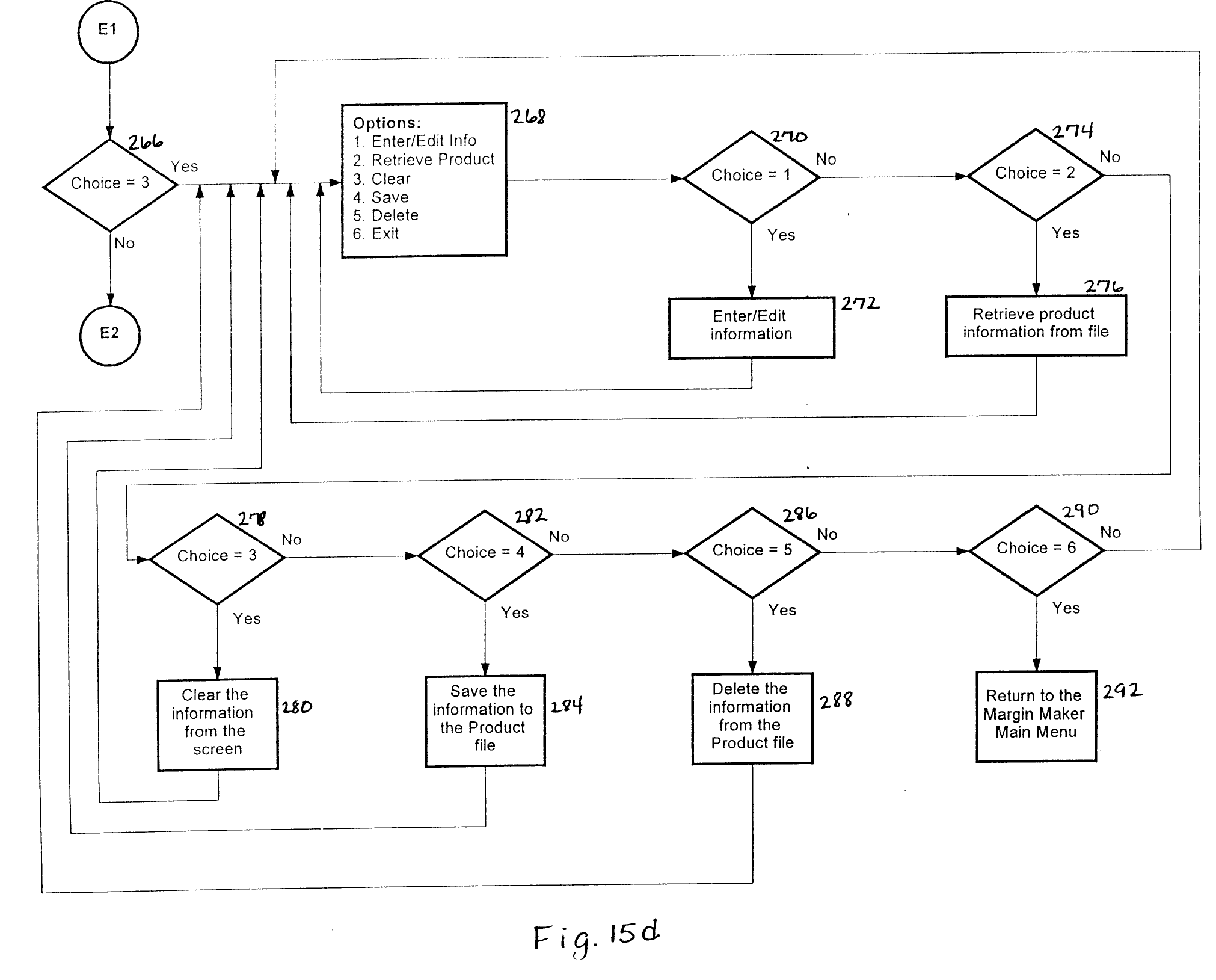

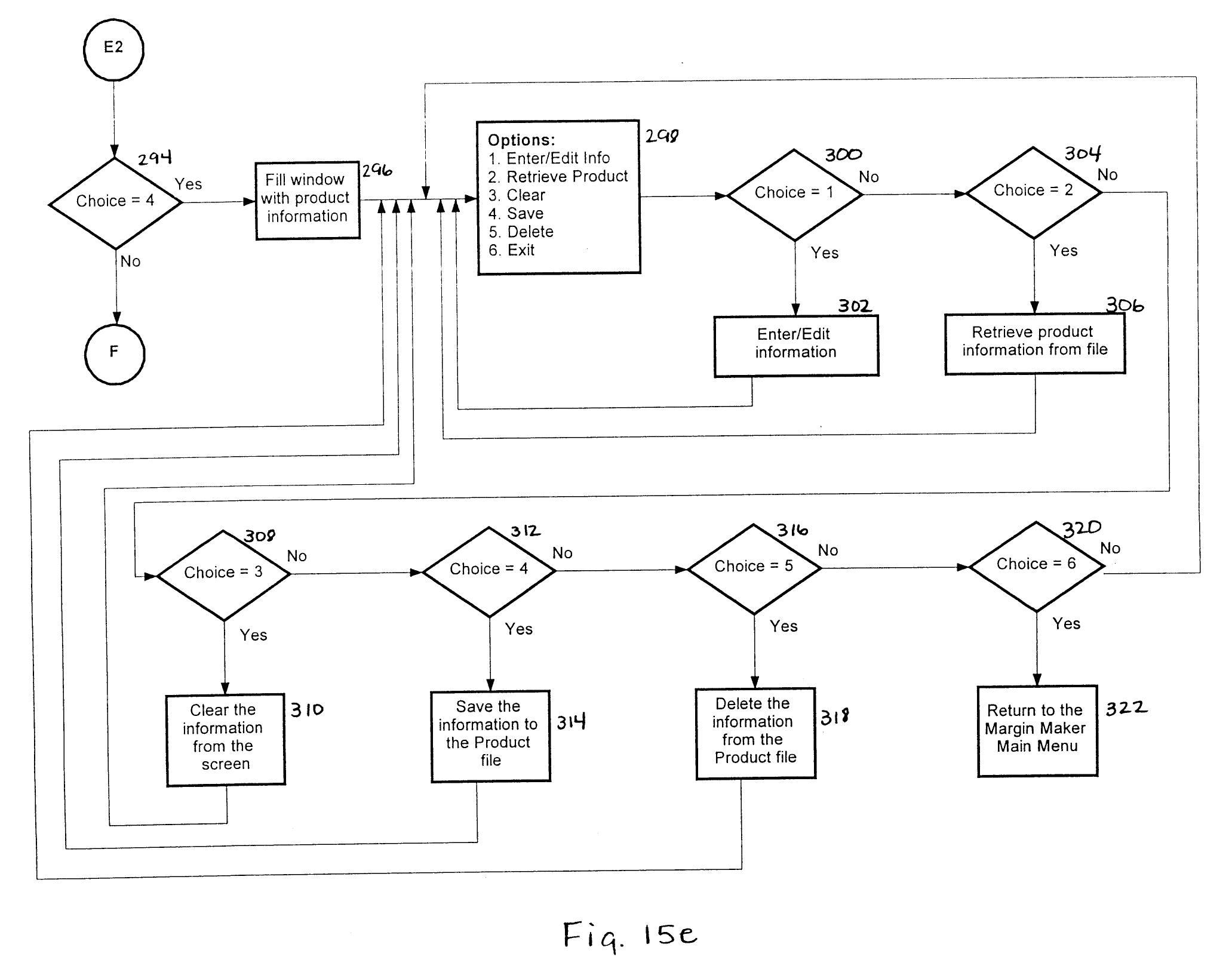

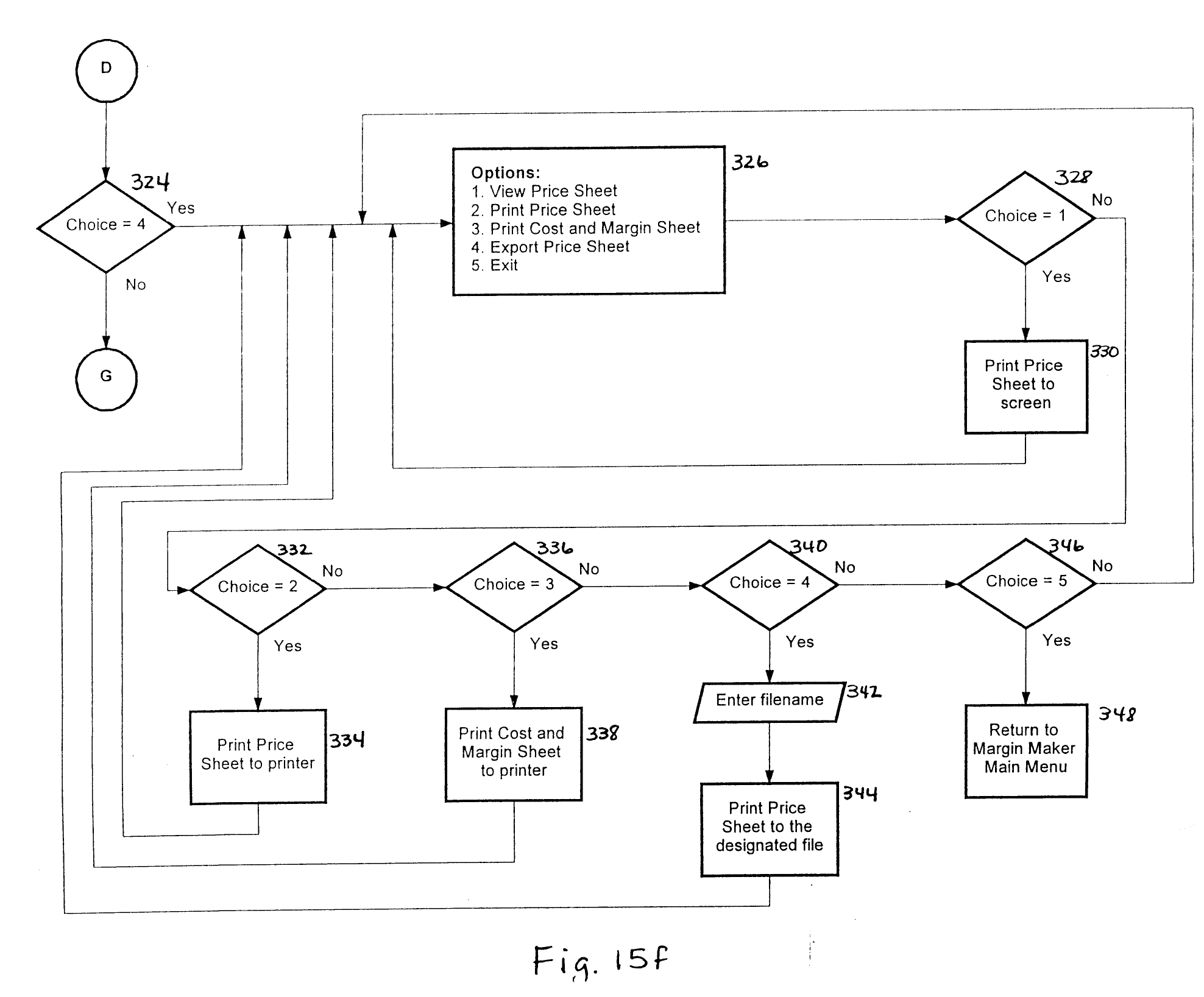

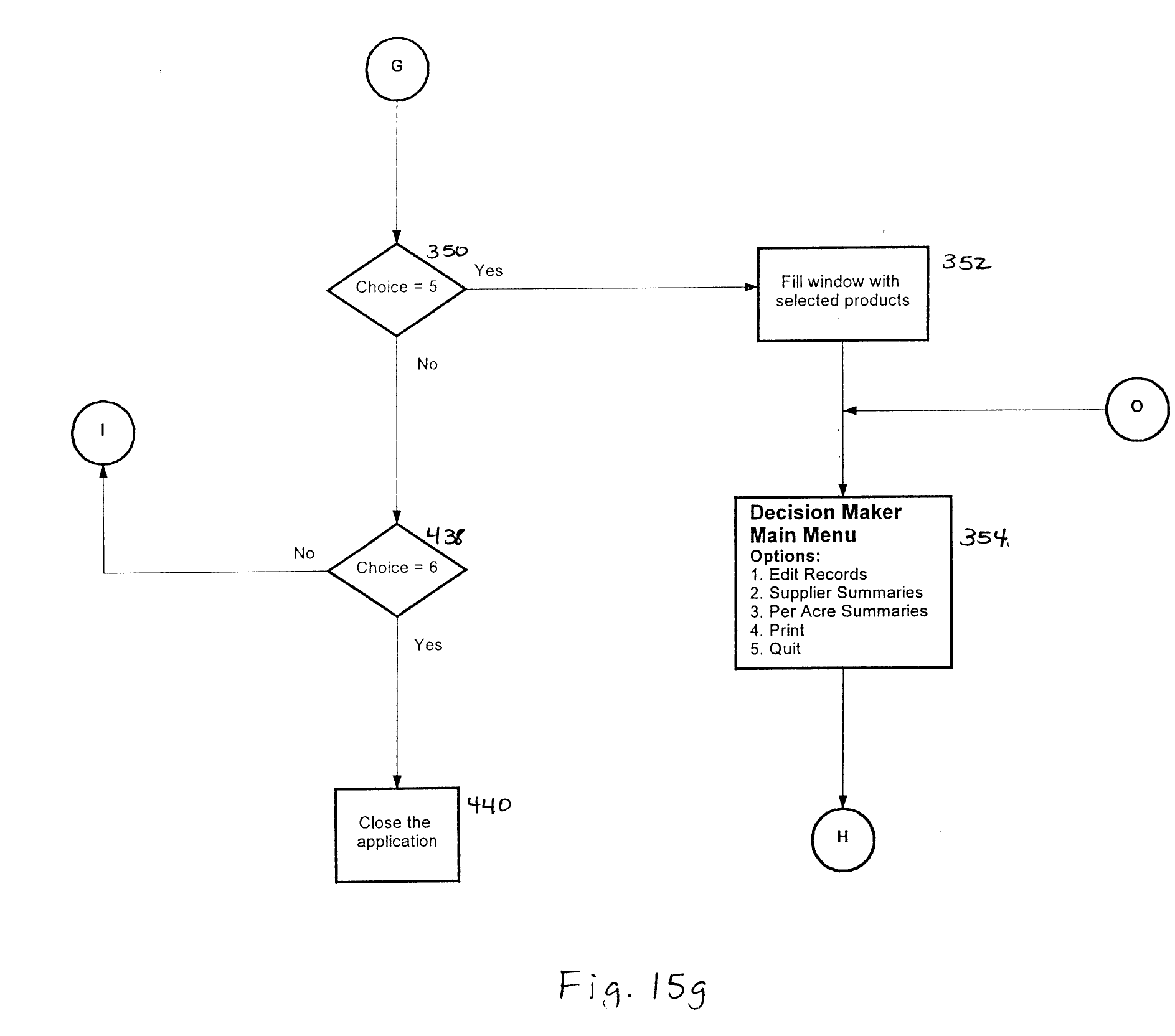

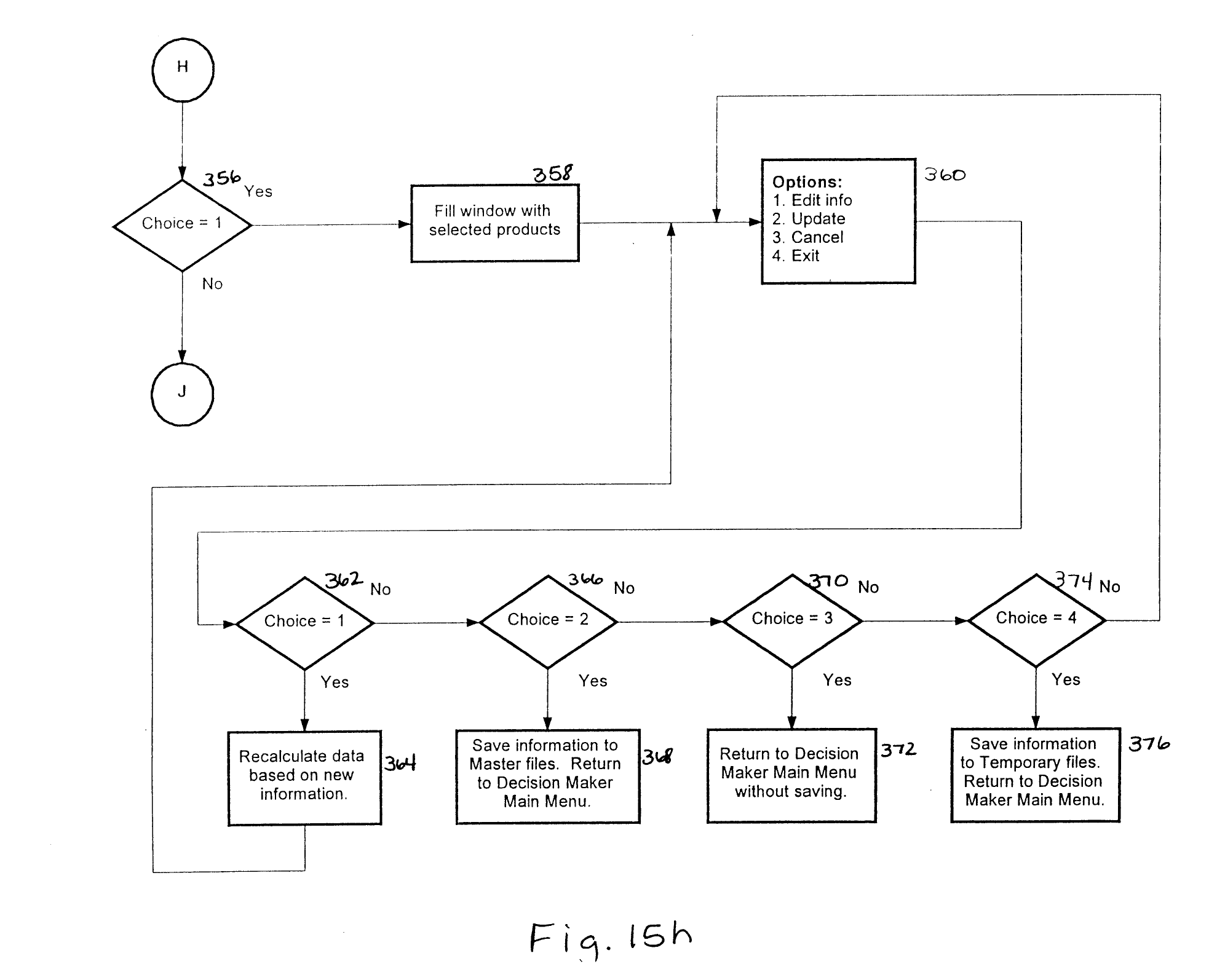

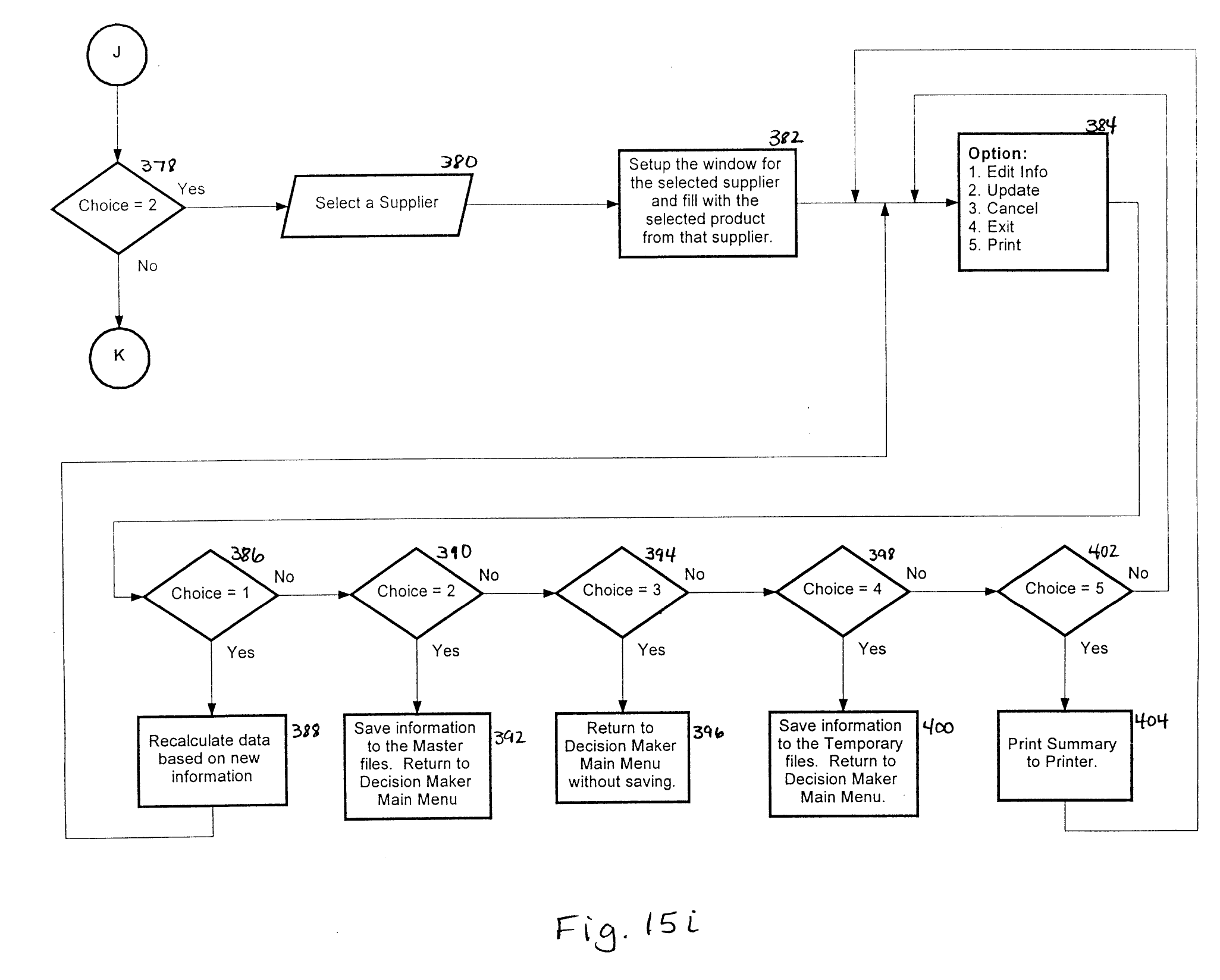

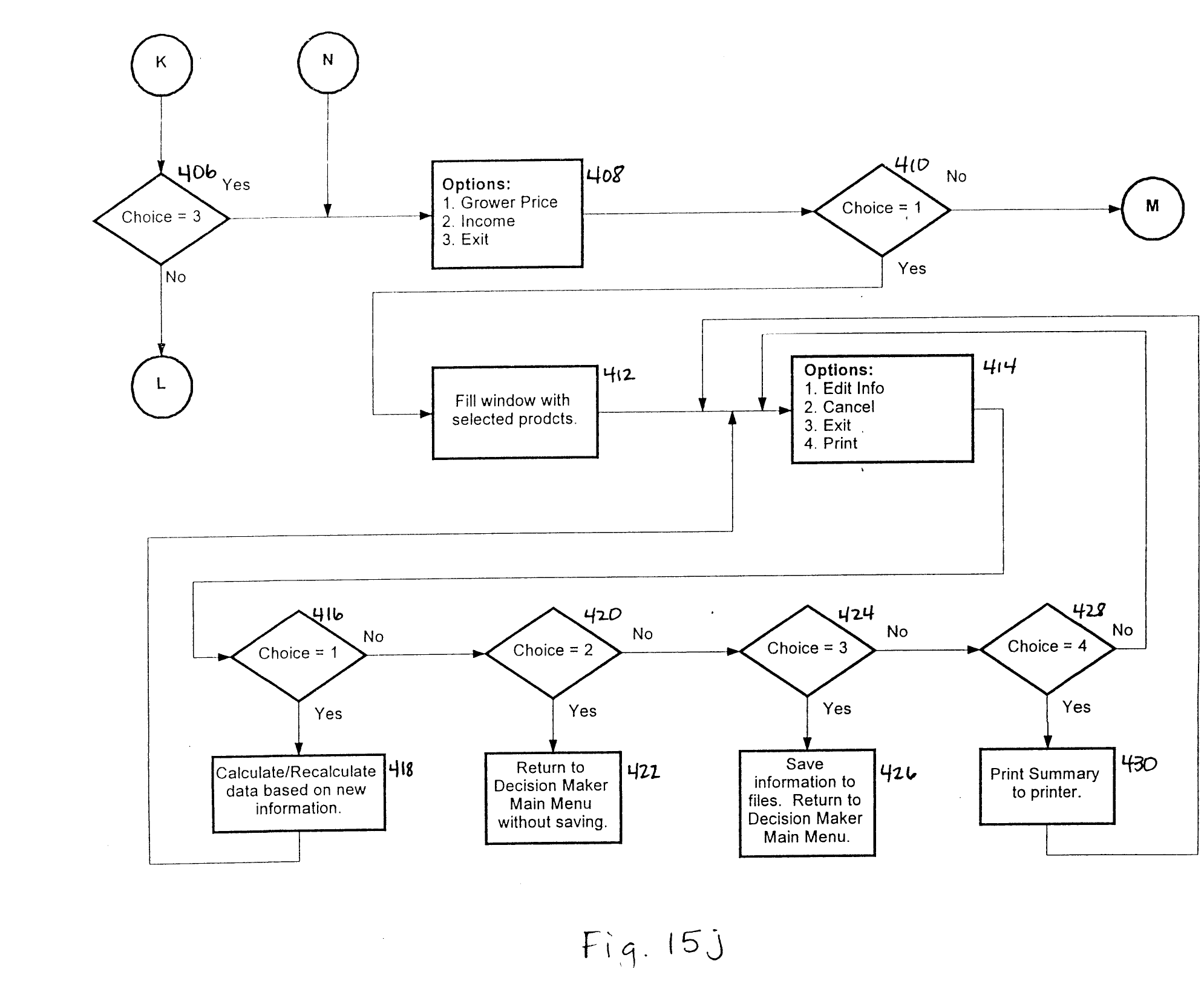

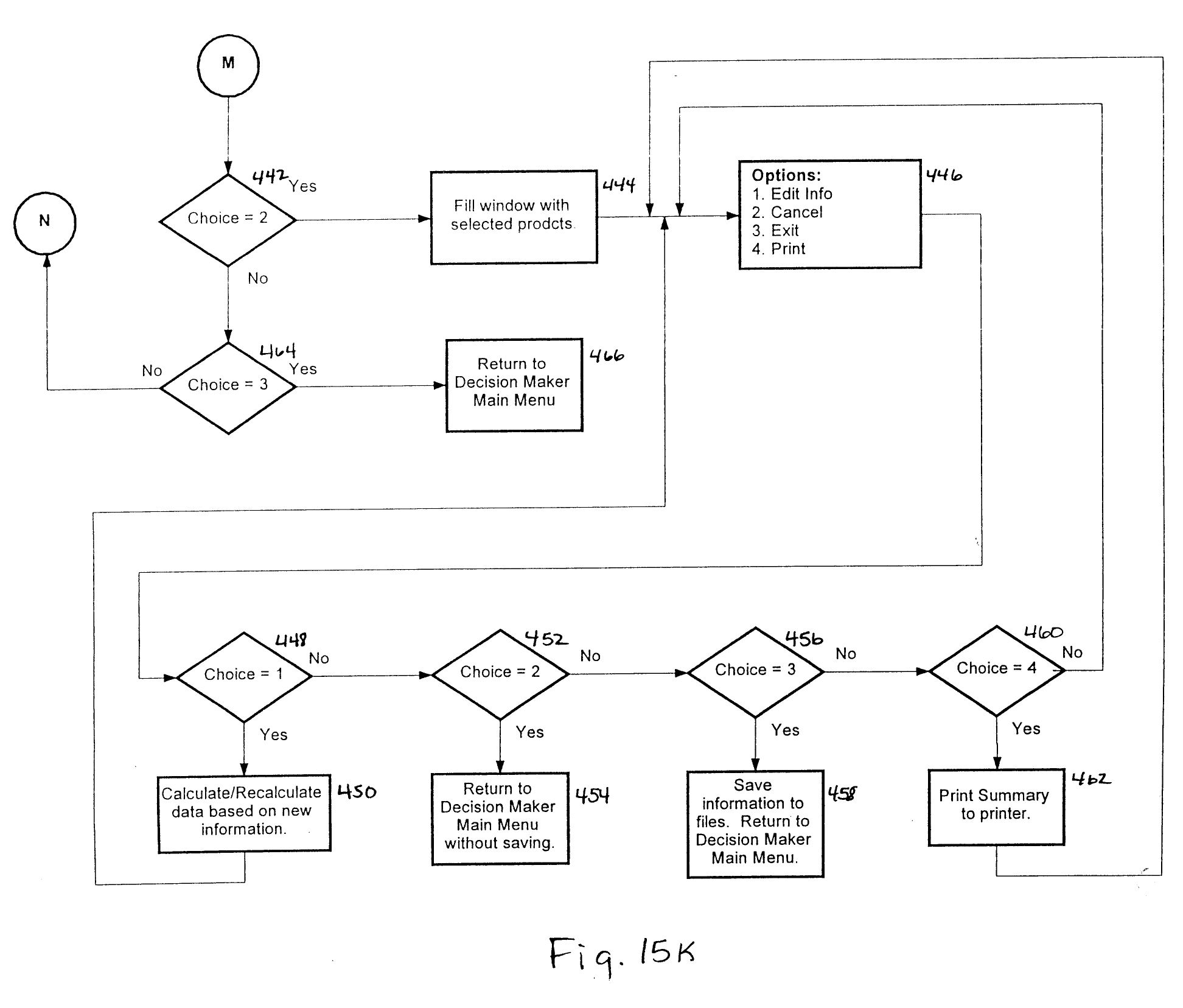

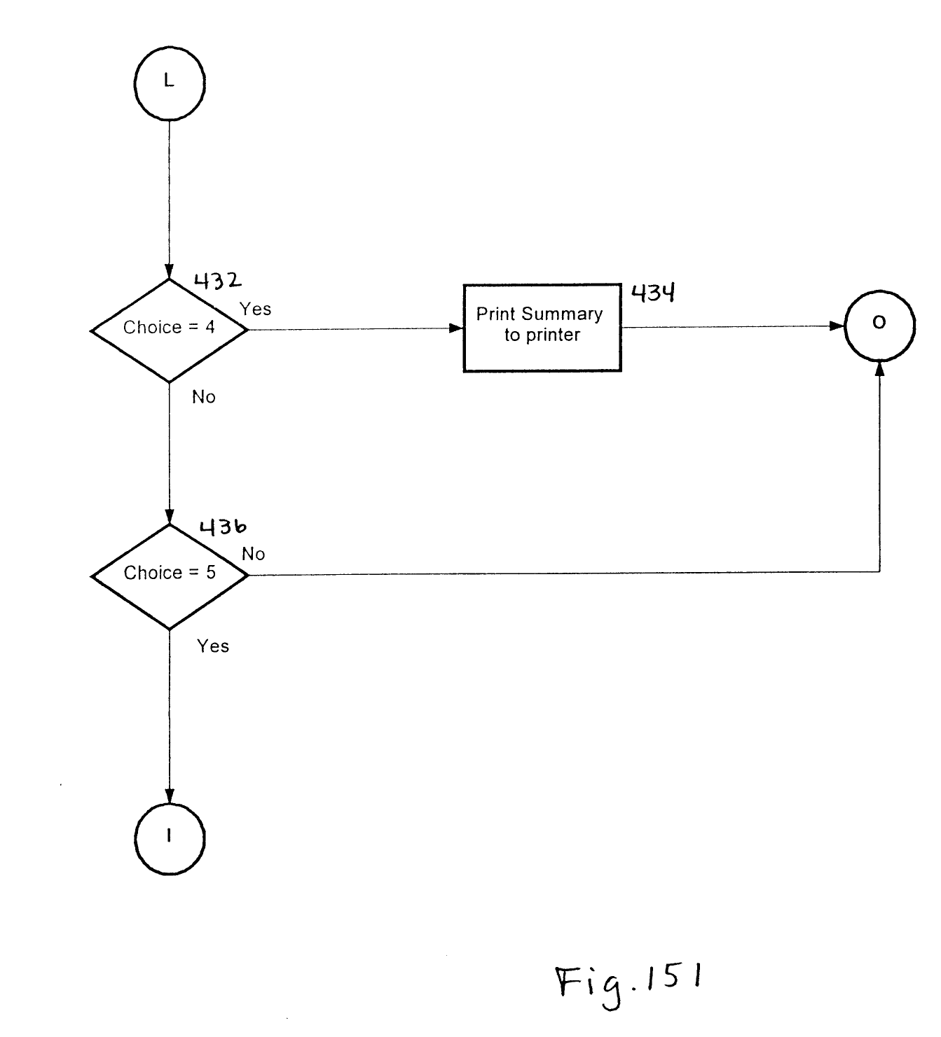

FIGS 15a-h are flow charts describing preferred system processing of both the MARGIN MAKER™ module and the DECISION MAKER™ module. It is to be understood that the margin determination and income forecasting system is not to be limited to the preferred flow of system processing shown in FIGS. 15a-15h and that the system could have other processing flow without departing from the scope of the present invention.

As shown in FIG. 15a, system processing begins 200 by filling a window with the selected products. After the window has been filled, the system opens the MARGIN MAKER™ module main menu 204, which has six options: choose products, set margins, edit products, view/print, the DECISION MAKER™ module, and quit. Selection of the choose products option 206, causes the choose products window screen (shown as 144 in FIG. 12c.) to be filled with all product records within the main product records database 208. There are two options within choose products: marking/unmarking of products 212 for product selection or exiting the choose products option 216 for return to the MARGIN MAKER™ module main menu 218.

Selection of the set margin option at the MARGIN MAKER™ module main menu 220 is shown in FIG. 15b. Upon choosing the set margins option 220, the set margins window screen (shown in FIG. 12d) is filled with product information 222. Within the set margins option the user typically has three options: entering/editing information, updating information already within the system, and exiting the set margins option 224. Choosing to enter or edit information 226, causes the system to calculate or recalculate product margin information based on data entered 228. The system is updated by these calculations or recalculations 230 at user request and saved for all products. System update closes set margins and returns the system to the MARGIN MAKER™ module main menu 232. The system also provides the option of exiting set margins 234 for a return to the MARGIN MAKER™ module main menu 236 without editing or updating information.

Selection of the Edit Products option at the MARGIN MAKER™ module main menu 238 is shown in FIG. 15c. (shown in FIG. 12f as screen 150). Within the edit products option 238, there are typically four options: exit, edit, add and change 240. Choosing to exit edit products 242, returns the system to the MARGIN MAKER™ module main menu 244. Choosing to edit the edit products option opens the edit products option that typically has four options: edit information, update information, restore, and exit 248. Choosing to edit product margin information 250 causes a recalculation of margin and price data based on the new information entered 252. Following system recalculation, this new information may be updated 254 and saved to the main product records database 256. Updating of main product records data base returns the user to the MARGIN MAKER™ module main menu 264. Choosing the restoration option 258, restores the product information to its original values 260. The exit option provides the option to exit the edit products option without any edits, updates or restorations 262. Such exiting returns the system to the MARGIN MAKER™ module main menu 264.

Choosing the add products option, as shown in FIG. 15d, within the edit products option, typically provides the user with six options; the entry/editing of information, retrieval of products, clear, save, delete or exit 268. Choosing add product's first option to enter/edit information 272, provides for the entering or editing of information 272. Upon completion of data entry/editing, the system provides for access to the Edit Products six options. Choosing add product's second option 274, causes the system to retrieve product information from the margin product records database 276. Choosing add product's third option 278, causes the system to clear information from the screen 280. Choosing add product's forth option 282, causes the system to save information changes made to the MARGIN MAKER™ module product records database 284. Choosing add product's fifth option 286, causes the system to delete 288 information from the margin product records previously added 288. Choosing add product's sixth option, causes the system to exit 290 the add products option and return to the MARGIN MAKER™ module main menu 292.

Choosing edit products fourth option to change a product is shown in FIG. 15e (shown in FIG. 12h as screen 154). Choosing the change product option causes the system to fill the window with product information 296. Change products normally provides for six options: edit/enter information 300, 302 the retrieval of product information from the margin module product record database 304, 306, the clearing of information from the screen 308, 310, the saving of information to the margin product records data base 312, 314, the deletion of information from the margin product records database 316, 318 and the exiting of change products 320 which returns the system to the MARGIN MAKER™ module main menu 322.

The MARGIN MAKER™ module View/Print options are shown in FIG. 15f (View/Print screen shown in FIG. 12i as screen 156). The view/print options typically provides for five options 326: the viewing of the price sheet report on screen 328, 330, the printing of the price sheet report to a printer 332, 334, the printing of the cost and margin sheet report to a printer 336, 338, the exporting of the price sheet report to a word processor file 340, 342, 344 and the exiting of the view print option 346, returning the system to the MARGIN MAKER™ module main menu 348.

Selection of the MARGIN MAKER™ module fifth option provides success to the DECISION MAKER™ module 350 as shown in FIG. 15g. Accessing the DECISION MAKER™ module (shown in FIG. 13a as screen 138) causes the system to fill the window with the products records that comprise margin product records data base. The DECISION MAKER™ module typically comprises six options: edit records, supplier summaries, per acre summaries, print and quit 354. Choosing Edit Records option 356 within the DECISION MAKER™ module, shown in FIG. 15h, causes the system to reload the Edit Records window with the product records that comprise the margin product records data base. The DECISION MAKER™ module Edit Records typically option has four options 360: edit information, update information, cancel and exit. Exercising Edit Records first option of editing information 362 causes the system to recalculate the margin and income data stored as price and cost reports based on the new information added 364. Exercising Edit Records second option of updating information 366 causes the system to save the information added at edit records in a master file 368. Exercising Edit Records third option of canceling information 370 causes the system to exit the DECISION MAKER™ module and return to the MARGIN MAKER™ module without saving any changes made 372. Exercising Edit Records forth option to exit 374, causes the system to exit the DECISION MAKER™ module and save any changes made to a temporary file 376.

Choosing the supplier summary option 378 within the DECISION MAKER™ module, shown in FIG. 15i, causes the system to prompt the user to select a supplier 380 (shown as a screen 162 in FIG. 3c). Upon selection of a supplier the system provides for the modification of the selected supplier window set up and for the filling of that supplier window with the selected products for that supplier 382. Supplier summary performs this function through the following options: edit information, update information, cancel, exit and print 384. Choosing supplier summary edit information option 386 provides for the entry of new data which the system uses to recalculate margin and price data based on the new information added 388. Selection of supplier summary update information option 390, causes the system to save the recalculated data to the master files and for the return to the DECISION MAKER™ module main menu 392. Choosing supplier summary cancelled option 394 causes the system to return to the DECISION MAKER™ module without saving any of the editing changes 396. Choosing supplier summary exit option 398 causes the system to save the information edited and add it to the system temporary files and for the return to the DECISION MAKER™ module main menu 400. Choosing supplier summary print option 402 causes the system to print a supplier summary report to a printer 404.

Selection of the DECISION MAKER™ module per acre summaries option 406, shown in FIG. 15j-15K, typically provides three options: grower price, income report generation and exit 408 (shown in FIG. 13f as screen 168). Choosing supplier summary grower price option 410 causes the price per acre screen/window to fill with the products within the margin product records database 412 (shown in FIG. 13g as screen 170). Supplier summary grower price option has four options: edit information, cancel, exit and print 414. Choosing grower price edit information option 416 provides for the editing of information shown at the grower price window which provides for the calculation or recalculation of data based on the new information added 418. Choosing he grower price cancel option 420 returns the system to the DECISION MAKER™ module main menu without saving any of the edited or added changes 422. Choosing grower price exit option 424 causes the system to save the information edited or added and for a return of the system to the DECISION MAKER™ module main menu 426. Choosing grower price print option 428 provides for the printing of a grower price report to a printer 430.

The selection of per acre summaries income option, shown in FIG. 15k causes the system to fill an income per acre screen/window with the product records from the margin product records database 444. The per acre summaries income option has four options: edit information, cancel information, exit and print 446. Choosing per acre summary edit information option 448 provides for the editing and adding of information to the information shown at the income per acre summary screen. The editing of such information at the income information screen causes the system to calculate or recalculate data based on changes made 450. Choosing the income per acre cancel option 452 causes the system to return to the DECISION MAKER™ module main menu without saving any changes made 454. Choosing income per acre summary exit option 456 provides for the saving of any information edited or changed and for the return to the the DECISION MAKER™ module main menu 458. Choosing the income per acre summary print option 460 provides for the printing of an income per acre summary report to a printer 462.

Selecting the DECISION MAKER™ module print option 432, shown in FIG. 15l provides for the printing of the DECISION MAKER™ module forecast pricing report to a printer 434, and for the closing of the DECISION MAKER™ module and an exit to the MARGIN MAKER™ module main menu 436.

What is claimed:

1. A computer-implemented margin income determination system for automatically determining margins of products sold across a selling period, comprising:
(a) terminal means for receiving and displaying data including product data identifying particular products, margin control data, margin income data, and beginning and ending dates defining a selling period;
(b) data storage electrically interconnected to said terminal means for storing said product data and said margin control data; and
(c) programmed processor means, electrically interconnected to said terminal means and said data storage, for processing said data received at said terminal, said programmed processor means including program means for processing said product data and said margin control data in order to automatically determine and display said margin income data across the selling period.

2. The system of claim 1 wherein:
(a) said terminal means comprises means for changing said product data; and
(b) said program means comprises means for automatically determining and displaying an updated margin income data across the selling period in response to said changed product data.

3. The system of claim 1 wherein said program means comprises means for automatically determining and displaying said margin income data across the selling period for each month within the selling period.

4. A computer implemented sales forecasting system for automically forecasting profits resulting from anticipated sales of products across a selling period comprising:
(a) terminal means for receiving and displaying data, including margin control data, manufacturer rebate control data and sales forecast variables;
(b) data storage electrically interconnected to said terminal means for storing said margin control data, manufacturer rebate control data and sales forecast variables;
(c) programmed processor means, electrically interconnected to said terminal means and said data storage, for processing said data received at the terminal, said programmed processor means including program means for processing said margin control data, said manufacturer rebate control data, said sales forecast variables and data retrieved from a margin determination data base to automatically determine and display forecasted profits on anticipated sales across the selling period.

5. The system of claim 4 wherein:
(a) said terminal means comprises means for changing said margin control data, said manufacturer rebate control data and said forecast variables; and
(b) said program means comprises means for automatically determining and displaying updated price, margin income and manufacturer rebate per unit for each product sold on a period ending date in response to said changed forecast variables, margin control and manufacturer rebate control data.

6. The system of claim 5 wherein the system program means includes a means for displaying and generating a price per acre report outlining income per acre on products sold.

7. The system of claim 5 wherein the system program means includes a means for displaying and generating a cost per acre report outlining cost per acre of products sold.

8. A method of computing margins on products based on data stored in a computer comprising the steps of:
(a) identifying products sold from a product listing database stored in the computer;
said product listing database specifying a plurality of products, each product being associated with a plurality of data fields, said data fields including product name and price;
(b) retrieving product data identified from said product listing database for storage on a modified database;
(c) storing said product data retrieved on said modified database;
(d) responding to system prompting at a templet having labeled data fields which define positions for entering a dealer input data set;
(e) entering said dealer input data set in said labeled data fields of said templet in response to system promptings;
(f) determining margin income data in response to computer calculations performed on data within said modified database and said dealer input data set; and
(g) displaying on said data entry terminal for each product of said modified data base a listing illustrating data within said plurality of data fields.

9. A computer implemented method for generating a price sheet for at least one product for a selling period, comprising the steps of:
(a) selecting a product having a product cost;
(b) generating an input data set in response to computer interrogation for use in determining elements of an array;
(c) determining elements of said array in response to computer manipulation of said product cost and said input data set, each element representing a product price and a varying profit margin for a portion of the selling period; and
(d) displaying said elements in an array.

10. The method of claim 9 wherein said input data set includes a product cost period defined by beginning and ending dates for said cost period.

11. The method of claim 9 wherein said input data set includes a dealer cost date.

12. The method of claim 9 wherein said input data set includes a cost of money.

13. The method of claim 9 wherein said element determination includes the step of determining a product base price, and wherein said input data set includes a first discount rate for specifying the amount by which said product base price is discounted.

14. The method of claim 9 wherein said element determination includes the step of determining a product base price, and wherein said input data set includes a second discount rate for specifying a discount from a base price for said product when paid on a discount pay date of said selling period.

15. The method of claim 9 wherein said input data set includes a margin for specifying the margin on sale of said product sold on a margin pay date of said selling period.

16. The method of claim 9 wherein said computer interrogation is prompted through templates, wherein said generation of said input set comprises the following steps:
(a1) responding to computer prompting by an option selection template by selecting a set margin option;
(a2) selecting said set margin option for accessing said set margin templet for input of said input data set; and
(a3) exiting said set margin option following said displaying of said array of elements and said associated margins, for return to said option selection templet.

17. The method of claim 16 wherein said selecting includes defaulting to said input data set previously entered if no changes desired.

18. The method of claim 17 wherein said defaulting comprises of the following steps:
(i) verifying said input data set previously entered and automatically positioned in a plurality or input data fields; and
(ii) selecting said input data set previously entered.

19. The method of claim 9 wherein said displaying occurs on a set margin templet and comprises positioning each element of said array of elements in a plurality of pricing fields on said set margin templet, said array of elements representing pricing at different times in said selling period, said displaying further includes positioning each margin associated with each element of said array in a plurality of margin fields on said set margin templet, said associated margins representing margins at different times in said selling period.

20. A computer implemented system as disclosed in claim 9 including the following steps:
(a) printing a price sheet illustrating for each product a price at a different time during said selling period; and
(b) printing a cost and margin sheet illustrating for each product a cost, and margins for beginning and ending dates of said selling period.

21. A computer implemented method of generating an array of prices across a selling period, for at least one product having a cost, wherein said prices vary and reflect a changing profit margin, comprising the steps of:
(a) entering a plurality of variables related to the sale of said product;
(b) determining a plurality of prices over said selling period in response to said cost and said variables entered to produce a targeted profit for sales over said selling period;
(c) creating an array of said prices in response to said price determination to illustrate said selling period;
(d) displaying said array of prices and said changing profit margins associated with each price of said array.

22. The method of claim 21 wherein said plurality of variables include margin data.

23. The method of claim 21 wherein said plurality of variables include a cost of money.

24. The method of claim 21 wherein said plurality of variables include beginning and ending dates for defining said selling period, and a user product cost date.

25. The method of claim 21 wherein said plurality of variables include discount rates.

26. A computer implemented method as disclosed in claim 21 wherein said method further includes the steps of:
(a) entering sales forecast variables for forecasting profits resulting from an anticipated number of products sold over said selling period;
(b) determining said forecasted profits in response to said sales forecast variables entered to produce an outline for said user for aiding said user in managing income and sales; and
(c) displaying said outline including said forecasted profits over said selling period.

27. The method of claim 26 wherein said sales forecast variables include said anticipated number of products sold.

28. The method of claim 26 wherein said sales forecast variables include a desired margin percentage.

29. The method of claim 26, wherein said sales forecast variables include a manufacture rebate percentage for each product.

30. The method of claim 26 including the step of adding additional income for forecasting total user income over said selling period.

31. The method of claim 26 wherein said outline further includes for each product, said price, a product name, an anticipated number of products sold, a margin income, a manufacturer rebate income, a margin percentage, a manufacture rebate percentage, said outline further including a summary comprising additional income, a margin percentage total, a sales total, a income total, a margin income total, and a manufacturer rebate total.

32. The method of claim 26 including the step of displaying a supplier summary specifying for each manufacturer total purchases income, total rebate, and an average percentage rebate.

33. The method of claim 32 wherein said supplier summary display format is dynamic and determined by a supplier's program.

34. The method of claim 26 wherein the steps of determining said forecasted profits includes forecasting income generated for each product sold on a per acre basis in response to user direction.

35. The method of claim 34 wherein income per acre is determined by performing the following steps:
(a) entering per acre sales forecast variables for each said product for aiding said user in determining which products to sell based on total acreage to which said products sold can be directed for maximizing profits;
(b) determining said forecasted income in response to said per acre sales forecast variables entered; and
(c) displaying said forecasted income.

36. The method of claim 35 wherein said per acre sales forecast variables include, a sales rate per acre and a unit of measure.

37. The method of claim 36 including the step of displaying a grower cost per acre summary, said summary specifying a cost per acre for each of said products sold.
